(19) United States
(12) Patent Application Publication
(10) Pub. No.: US 2005/0175935 A1
(43) Pub. Date: Aug. 11, 2005

(54) Polymer, resist composition, and patterning process

(75) Inventors: Yuji Harada, Joetsu-shi (JP); Jun Hatakeyama, Joetsu-shi (JP); Yoshio Kawai, Joetsu-shi (JP); Masaru Sasago, Osaka (JP); Masayuki Endo, Osaka (JP); Shinji Kishimura, Itami-shi (JP); Kazuhiko Maeda, Tokyo (JP); Haruhiko Komoriya, Kawagoe-shi (JP); Kazuhiro Yamanaka, Kawagoe-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/052,214

(22) Filed: Feb. 8, 2005

(30) Foreign Application Priority Data
Feb. 9, 2004 (JP) 2004-031526

(51) Int. Cl. G03C 1/76

(52) U.S. Cl. 430/270.1

(57) ABSTRACT

A chemically amplified resist composition comprising an alternating copolymer of an acrylate monomer having a fluoroalkyl group at alpha-position with a norbornene derivative, when processed through ArF excimer laser exposure by lithography, is improved in resolution and dry etching resistance and minimized in line edge roughness.

### CROSS-REFERENCE TO RELATED APPLICATION

This non-provisional application claims priority under 35 U.S.C. §119(a) on Patent application No. 2004-031526 filed in Japan on Feb. 9, 2004, the entire contents of which are hereby incorporated by reference.

This invention relates to a resist composition suited for micropatterning technology. More particularly, it relates to a polymer useful as a base polymer in such resist compositions, a chemically amplified resist composition comprising the same, and a patterning process using the resist composition.

### BACKGROUND OF THE INVENTION

In the drive for higher integration and operating speeds in LSI devices, the pattern rule is made drastically finer. The rapid advance toward finer pattern rules is grounded on the development of a projection lens with an increased NA, a resist material with improved performance, and exposure light of a shorter wavelength. To the demand for a resist material with a higher resolution and sensitivity, chemically amplified positive working resist materials that utilize as a catalyst the acid generated upon light exposure are effective as disclosed in U.S. Pat. No. 4,491,628 and U.S. Pat. No. 5,310,619 (JP-B 2-27660 and JP-A 63-27829). They now become predominant resist materials especially adapted for deep UV lithography. Also, the change-over from i-line (365 nm) to shorter wavelength KrF excimer laser (248 nm) brought about a significant innovation. Resist materials adapted for KrF excimer lasers enjoyed early use on the 0.30 micron process, proceeded through the 0.25 micron, 0.18 micron and 0.13 micron rules, and currently entered the mass production phase on the 0.09 micron rule. Engineers have started investigation on the 0.065 micron rule, with the trend toward a finer pattern rule being accelerated.

An ArF excimer laser (193 nm) is expected to enable miniaturization of the design rule to 0.13 μm or less. Conventional novolac resins and polyvinylphenol resins cannot be used as the base resin for ArF excimer laser resists because they have very strong absorption in proximity to 193 nm. To ensure transparency and dry etching resistance, some engineers investigated acrylic and alicyclic (typically cycloolefin) resins as disclosed in JP-A 9-73173, JP-A 10-10739, JP-A 9-230595 and WO 97/33198.

One of the problems from which the ArF resists suffer is substantial line edge roughness. In general, a higher light contrast leads to a less line edge roughness. For example, increased NA of lens, application of modified illumination or phase shift mask, or wavelength reduction allows the light contrast to be increased, resulting in a reduced line edge roughness. Thus the wavelength reduction from KrF to ArF excimer laser is expected to reduce line edge roughness. However, it is reported in Proc. SPIE, Vol. 3999, p. 264 (2000) that ArF resists actually have greater line edge roughness than KrF resists and that image contrast is in inverse proportion to line edge roughness. This is attributable to the difference in performance between ArF and KrF resists. Another problem is that ArF resists have weak etching resistance as compared with KrF resists. In particular, a problem that roughness is developed on the surface after etching and transferred to the substrate as striations is pointed out in Proc. SPIE, Vol. 3678, p. 1209 (1999) and Proc. SPIE, Vol. 5039, p. 665 (2003). Also the use of an alternating copolymer as the base is proposed as one of effective means for minimizing the edge roughness of a pattern after development, as reported in Proc. SPIE, Vol. 5039, p. 672 (2003). The alternating copolymer in which recurring units are arranged in order within the polymer chain is characterized by its ability to minimize edge roughness, as compared with random and block copolymers.

### SUMMARY OF THE INVENTION

An object of the invention is to provide a novel polymer useful as a base polymer in a resist composition, especially chemically amplified resist composition, having improved transmittance to deep UV radiation of up to 300 nm, especially of ArF (193 nm); a resist composition comprising the same; and a patterning process using the composition.

The inventor has discovered that the use of a copolymer of an acrylate monomer containing fluorine at alpha-position with a norbornene derivative as a base polymer enables to formulate a chemically amplified resist composition having improved resolution and dry etching resistance and minimized line edge roughness. Specifically, copolymerization proceeds alternately between an acrylate monomer having a fluoroalkyl group at alpha-position as represented by formula (1a) and a norbornene derivative as represented by formula (1b). A resist using the resulting copolymer is minimized in surface roughness after etching and exhibits excellent resistance to dry etching.

In one aspect, the invention provides a polymer comprising recurring units of the general formulae (1a) and (1b) and having a weight average molecular weight of 1,000 to 500,000. 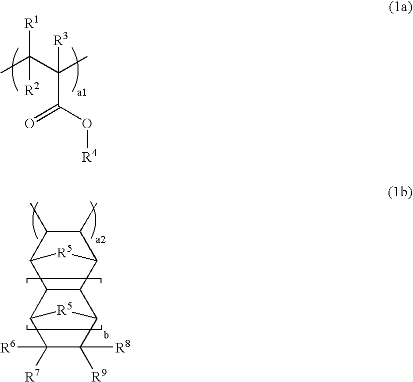
Herein R¹ and R² each are a hydrogen or fluorine atom, R³ is a luorine atom or a straight, branched or cyclic fluoroalkyl roup of 1 to 20 carbon atoms, R⁴ is hydrogen or an adhesive group, R⁵ is a methylene group or oxygen atom, R⁶ to R⁹ each are a hydrogen atom, fluorine atom, cyano group, straight, branched or cyclic alkyl or fluoroalkyl group of 1 to 20 carbon atoms, —OR¹, —R¹⁰—CO₂R¹¹ or —R¹⁰—C(R¹²)(R¹³)—OR¹¹, R¹⁰ is a straight, branched or cyclic alkylene or fluoroalkylene group of 1 to 10 carbon atoms, R¹¹ is hydrogen or an acid labile group, R¹² and R¹³ each are hydrogen or a straight, branched or cyclic alkyl or fluoroalkyl group of 1 to 10 carbon atoms, at least one of R⁶ to R⁹ contains —R¹⁰—CO₂R¹¹ or —R¹⁰—C(R¹²)(R¹³)—OR¹¹, at least 5 mol % of R¹¹ are acid labile groups, the subscripts a1 and a2 are numbers satisfying 0<a1<1, 0<a2<1, and 0<a1+a2≦1, and b is 0 or 1. Typically, R³ is trifluoromethyl.

In a second aspect, the invention provides a resist composition comprising the inventive polymer. More specifically, a chemically amplified positive resist composition comprising (A) the inventive polymer, (B) an organic solvent, and (C) a photoacid generator is provided. The chemically amplified positive resist composition may further comprise (D) a basic compound and/or (E) a dissolution inhibitor.

In a third aspect, the invention provides a process for forming a pattern comprising the steps of (1) applying the resist composition onto a substrate to form a coating, (2) heat treating the coating and then exposing it to high-energy radiation having a wavelength of up to 200 nm through a photomask, and (3) optionally heat treating the exposed coating and developing it with a developer. The high-energy radiation is typically an ArF excimer laser beam.

Since an alternating copolymer of an acrylate monomer containing fluorine at a-position and having an adhesive group incorporated therein with a norbornene derivative having an acid labile group or leaving group is used as the base resin, the resist composition of the invention exhibits a high sensitivity to high-energy radiation, especially at wavelengths of up to 200 nm, and minimized edge roughness as well as excellent plasma etching resistance and high transparency. Due to these advantages, the inventive resist composition shows minimal absorption at the exposure wavelength of an ArF excimer laser, can form a finely defined pattern having sidewalls perpendicular to the substrate, and is thus ideal as a micropatterning material in VLSI fabrication.

### DESCRIPTION OF THE PREFERRED EMBODIMENTS

Polymer

One embodiment of the invention is a polymer or high molecular weight compound comprising recurring units having the general formulae (1a) and (1b).

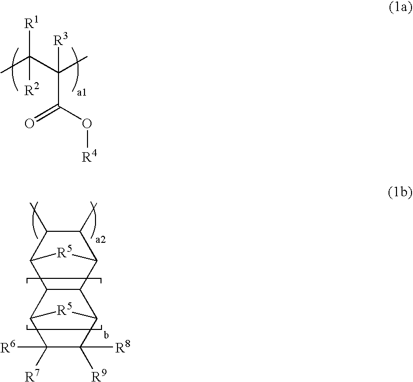

Herein R¹ and R² each are a hydrogen or fluorine atom. R³ is a fluorine atom or a straight, branched or cyclic fluoroalkyl group of 1 to 20 carbon atoms. R⁴ is hydrogen or an adhesive group. R⁵ is a methylene group or oxygen atom. R⁶ to R⁹ each are a hydrogen atom, fluorine atom, cyano group, straight, branched or cyclic alkyl or fluoroalkyl group of 1 to 20 carbon atoms, —OR¹¹, —R¹⁰—CO₂R¹¹ or —R¹⁰—C(R¹²)(R¹³)—OR¹¹. R¹⁰ is a straight, branched or cyclic alkylene or fluoroalkylene group of 1 to 10 carbon atoms. R¹¹ is hydrogen or an acid labile group. R¹² and R¹³ each are hydrogen or a straight, branched or cyclic alkyl or fluoroalkyl group of 1 to 10 carbon atoms. At least one of R⁶ to R⁹ contains —R¹⁰—CO₂R¹ or —R¹⁰—C(R¹²)(R¹³)—OR¹¹, and at least 5 mol % of R¹¹ groups are acid labile groups. The subscripts a1 and a2 are numbers satisfying 0<a1<1, 0<a2<1, and 0 <a1+a2≦1, and b is 0 or 1.

Examples of the straight, branched or cyclic alkyl group of 1 to 20 carbon atoms include methyl, ethyl, propyl, isopropyl, n-propyl, sec-butyl, tert-butyl, cyclopentyl, cyclohexyl, 2-ethylhexyl, and n-octyl, with those groups having 1 to 12 carbon atoms, especially 1 to 10 carbon atoms being preferred. Fluoroalkyl groups are the foregoing alkyl groups in which some or all of the hydrogen atoms are replaced by fluorine atoms, such as, for example, trifluoromethyl, pentafluoroethyl, heptafluoropropyl and nonafluorobutyl. Examples of the straight, branched or cyclic alkylene group of 1 to 10 carbon atoms correspond to the foregoing alkyl groups with one hydrogen being eliminated. Fluoroalkylene groups correspond to those alkylene groups which are partially or entirely substituted with fluorine atoms.

Examples of recurring units (1a) are given below, but not limited thereto. 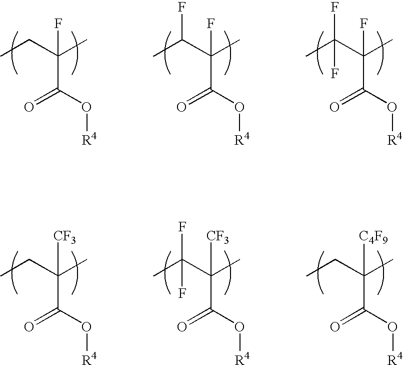
Herein R⁴ is hydrogen or an adhesive group.

Examples of recurring units (1b) are given below, but not limited thereto. 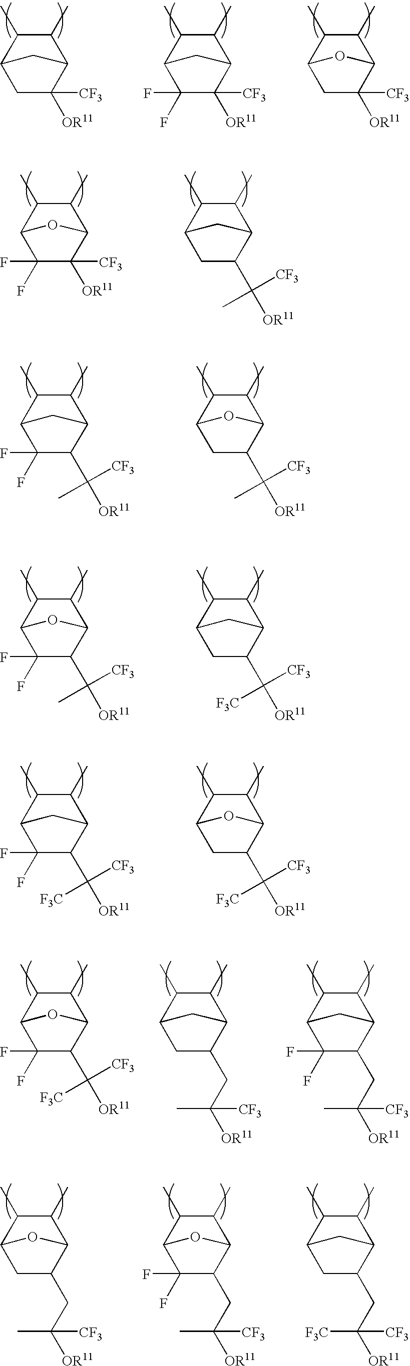 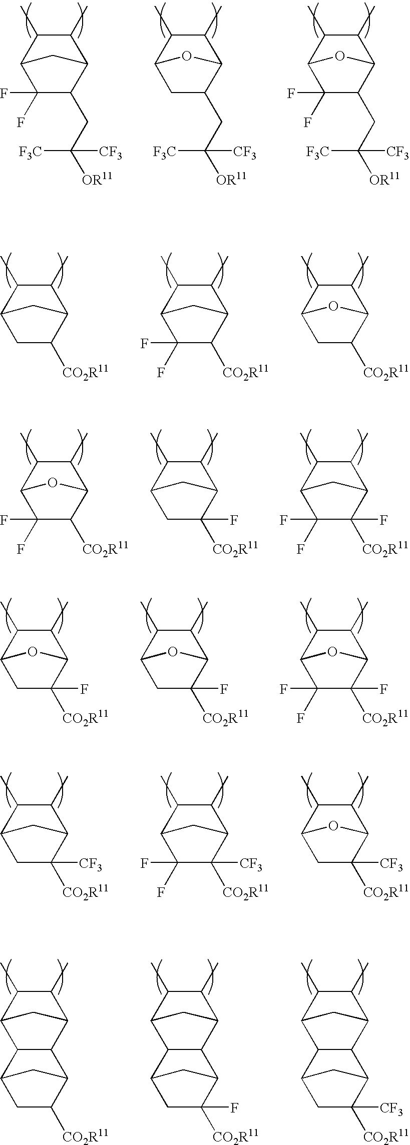
Herein R¹¹ is hydrogen or an acid labile group.

The adhesive group represented by R⁴ is selected from a variety of such groups, preferably from among the groups of the following formulae.

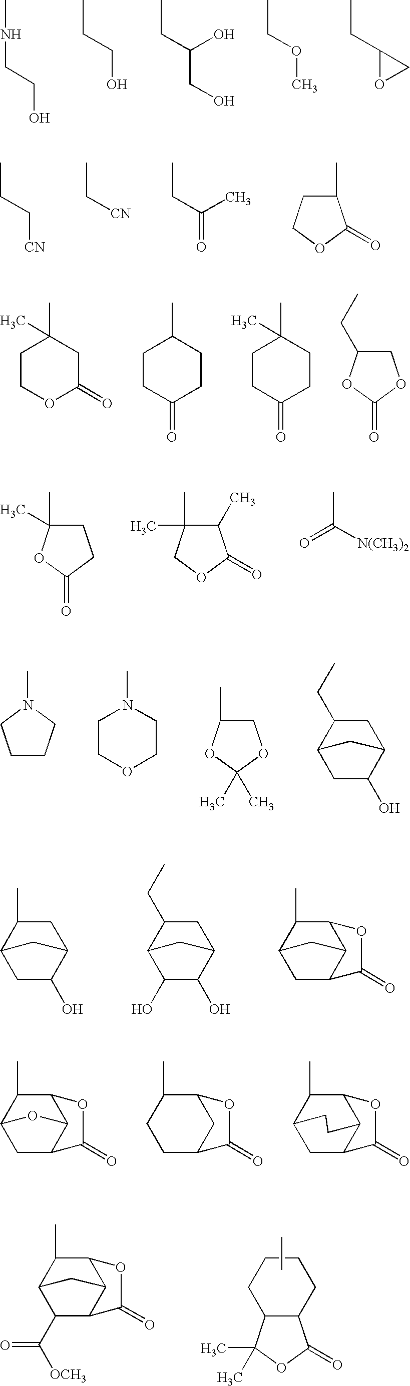

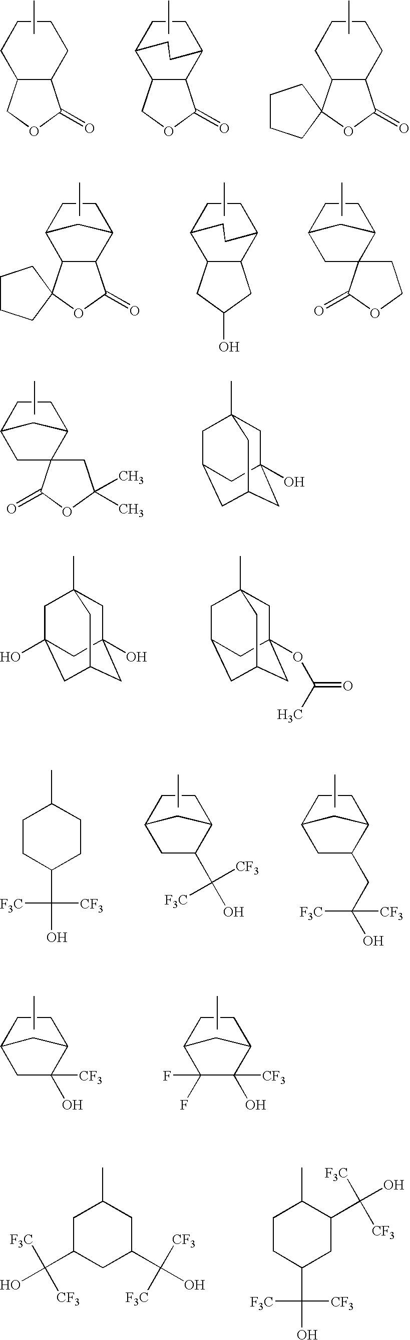

The acid labile group represented by R¹¹ is selected from a variety of such groups, preferably from among the groups of the following formulae (AL-1) to (AL-3).

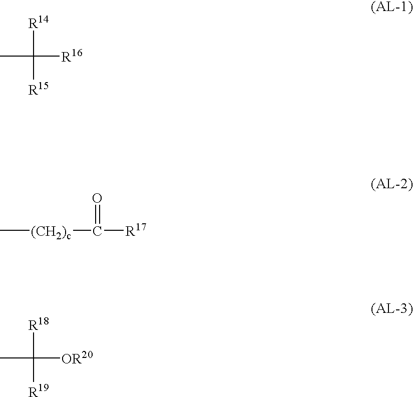

Herein, R¹⁴, R¹⁵ and R¹⁶ may be the same or different and stand for straight, branched or cyclic hydrocarbon groups of 1 to 20 carbon atoms, which may contain a hetero atom such as oxygen, sulfur or nitrogen, or bridged cyclic hydrocarbon groups. Alternatively, a pair of R¹⁴ and R¹⁵, R¹⁴ and R¹⁶, and R¹⁵ and R¹⁶, taken together, may form a ring of 5 to 20 carbon atoms, preferably 5 to 15 carbon atoms, with the carbon atom to which they are bonded. R¹⁷ and R²⁰ stand for straight, branched or cyclic alkyl groups of 1 to 20 carbon atoms, which may contain a hetero atom such as oxygen, sulfur, nitrogen or fluorine. R¹⁸ and R¹⁹ stand for hydrogen or straight, branched or cyclic alkyl groups of 1 to 20 carbon atoms, which may contain a hetero atom such as oxygen, sulfur, nitrogen or fluorine. Alternatively, a pair of R¹⁸ and R¹⁹, R¹⁸ and R²⁰, and R¹⁹ and R²⁰, taken together, may form a ring of 5 to 20 carbon atoms, preferably 5 to 15 carbon atoms, with the carbon atom or carbon and oxygen atoms to which they are bonded. The subscript c is an integer of 0 to 6.

In formula (AL-1), illustrative examples of R¹⁴, R¹⁵ and R¹⁶ include methyl, ethyl, n-propyl, isopropyl, tert-butyl, cyclohexyl, cyclopentyl, norbornyl, adamantyl, and menthyl. The acid labile groups of formula (AL-1) are exemplified by the substituent groups shown below.

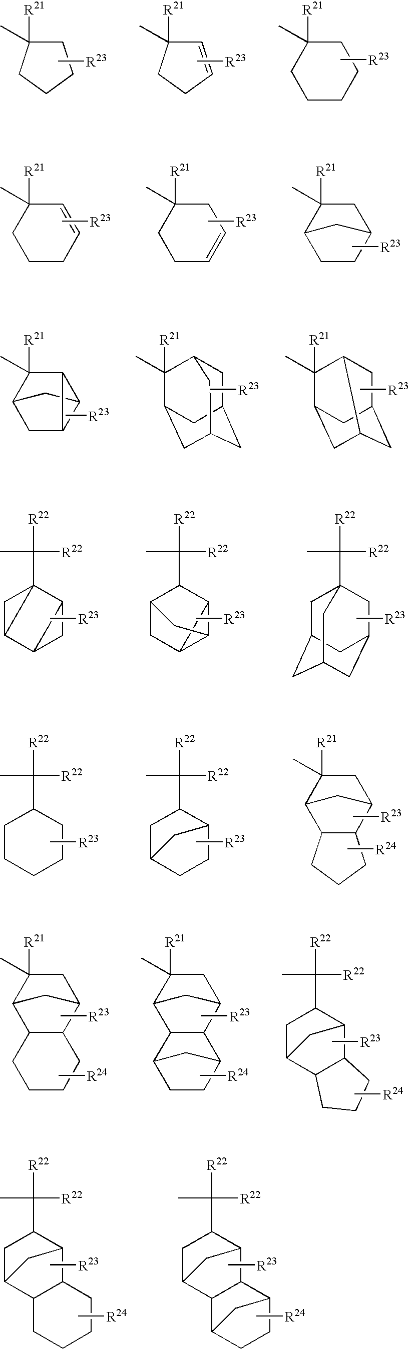

Herein, R²¹ and R²² stand for straight, branched or cyclic alkyl groups of 1 to 20 carbon atoms, preferably 1 to 10 carbon atoms. R²³ and R²⁴ stand for hydrogen or monovalent hydrocarbon groups of 1 to 6 carbon atoms, typically alkyl, which may contain a hetero atom and which may be straight, branched or cyclic.

Illustrative examples of R²¹ and R²² include methyl, ethyl, propyl, isopropyl, n-butyl, sec-butyl, n-pentyl, n-hexyl, cyclopropyl, cyclopropylmethyl, cyclobutyl, cyclopentyl, and cyclohexyl. Illustrative of R²³ and R²⁴ are alkyl, hydroxyalkyl, alkoxy, and alkoxyalkoxy groups, examples of which include.methyl, ethyl, n-propyl, isopropyl, n-butyl, sec-butyl, n-pentyl, n-hexyl, hydroxymethyl, hydroxyethyl, methoxy, methoxymethoxy, ethoxy, and tert-butoxy. When R²³ and R²⁴ contain hetero atoms such as oxygen, sulfur or nitrogen, they may be contained, for example, in the form of —OH, —OR²⁵, —O—, —S—, —S(═O)—, —NH₂, —NHR²⁵, —N(R²⁵ )₂, —NH— or —NR²⁵— wherein R²⁵ is a C₁-C₅ alkyl group.

Illustrative examples of the acid labile groups of formula (AL-2) include tert-butoxycarbonyl, tert-butoxycarbonylmethyl, tert-amyloxycarbonyl, tert-amyloxycarbonylmethyl, 1,1-diethylpropyloxycarbonyl, 1,1-diethylpropyloxycarbonylmethyl, 1-ethylcyclopentyloxycarbonyl, 1-ethylcyclopentyloxycarbonylmethyl, 1-ethyl-2-cyclopentenyloxycarbonyl, 1-ethyl-2-cyclopentenyloxycarbonylmethyl, 1-ethoxyethoxycarbonylmethyl, 2-tetrahydropyranyloxycarbonylmethyl, and 2-tetrahydrofuranyloxycarbonylmethyl.

Of the acid labile groups having formula (AL-3), examples of cyclic groups include tetrahydrofuran-2-yl, 2-methyltetrahydrofuran-2-yl, tetrahydropyran-2-yl, and 2-methyltetrahydropyran-2-yl. Straight and branched groups are exemplified by the following groups.

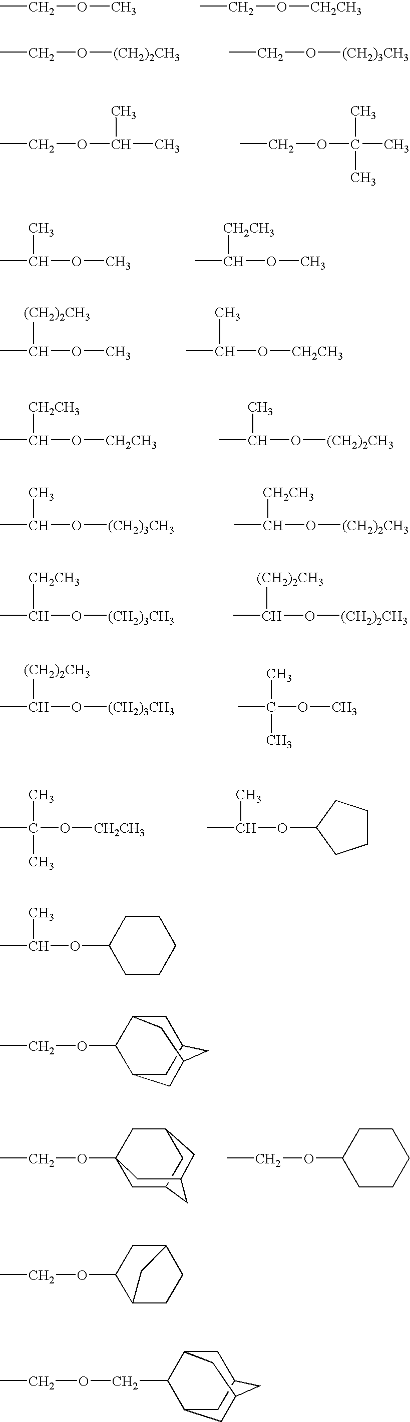

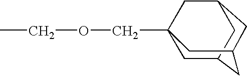

Of these groups, ethoxyethyl, butoxyethyl and thoxypropyl are preferred.

While the polymers of the invention are fully adhesive even with only the adhesive groups R⁴, any recurring units selected from the following list of formula (1c) may be further included for further improving adhesion. 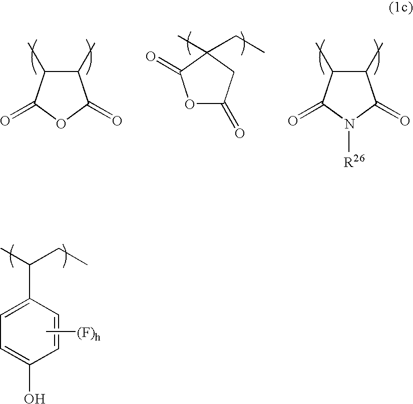
Herein R²⁶ is a straight, branched or cyclic alkyl group of 1 to 10 carbon atoms, and h is a number of 0 to 4.

Provided that U1 represents the content of units of formula (1a), U2 represents the content of units of formula (1b), and U3 represents the content of adhesion-improving units (1c), as expressed in molar ratio, and U1+U2+U3=1, the polymers of the invention preferably satisfy the range:

0<U1≦0.8, more preferably 0.1≦U1≦0.6,

0<U2≦0.7, more preferably 0.1≦U2≦0.5,

0≦U3≦0.5, more preferably 0≦U3≦0.3.

The inventive polymers are generally synthesized by dissolving monomers corresponding to units of formulae (1a) and (1b), and an optional adhesion-improving monomer in a solvent, adding a catalyst thereto, and effecting polymerization reaction while heating or cooling the system if necessary. The polymerization reaction depends on the type of initiator or catalyst, trigger means (including light, heat, radiation and plasma), and polymerization conditions (including temperature, pressure, concentration, solvent, and additives). Commonly used for the polymerization of the monomers are radical polymerization of triggering polymerization with radical polymerization initiators such as azobisisobutyronitrile, and ion (anion) olymerization using catalysts such as alkyl lithium. Such olymerization may be effected in a conventional manner.

The radical polymerization initiator used herein is not critical. Exemplary initiators include azo compounds such as 2,2′-azobisisobutyronitrile (AIBN), 2,2′-azobis(4-methoxy-2,4-dimethylvaleronitrile), 2,2′-azobis(2,4-dimethylvaleronitrile), and 2,2′-azobis(2,4,4-trimethylpentane); peroxide compounds such as tert-butyl peroxypivalate, lauroyl peroxide, benzoyl peroxide and tert-butyl peroxylaurate; water-soluble initiators, for example, persulfate salts such as potassium persulfate; and redox combinations of potassium persulfate or peroxides such as hydrogen peroxide with reducing agents such as sodium sulfite. The amount of the polymerization initiator used is determined as appropriate in accordance with such factors as the identity of initiator and polymerization conditions, although the amount is often in the range of about 0.001 to 5% by weight, especially about 0.01 to 2% by weight based on the total weight of monomers to be polymerized.

For the polymerization reaction, a solvent may be used. The polymerization solvent used herein is preferably one which does not interfere with the polymerization reaction. Typical solvents include ester solvents such as ethyl acetate and n-butyl acetate, ketone solvents such as acetone, methyl ethyl ketone and methyl isobutyl ketone, aliphatic or aromatic hydrocarbon solvents such as toluene, xylene and cyclohexane, alcohol solvents such as isopropyl alcohol and ethylene glycol monomethyl ether, and ether solvents such as diethyl ether, dioxane, and tetrahydrofuran. These solvents may be used alone or in admixture of two or more. Further, any of well-known molecular weight modifiers such as dodecylmercaptan may be used in the polymerization system.

The temperature of polymerization reaction varies in accordance with the identity of polymerization initiator and the boiling point of the solvent although it is often preferably in the range of about 20 to 200° C., and especially about 50 to 140° C. Any desired reactor or vessel may be used for the polymerization reaction.

From the solution or dispersion of the polymer thus obtained, the organic solvent or water serving as the reaction medium is removed by any of well-known techniques. Suitable techniques include, for example, re-precipitation followed by filtration, and heat distillation under reduced pressure.

Desirably the polymer has a weight average molecular weight (Mw) of about 1,000 to about 500,000, and especially about 2,000 to about 100,000, as measured by gel permeation chromatography (GPC) using polystyrene standards.

The polymer of the invention can be used as a base resin in resist compositions, specifically chemically amplified resist compositions, and especially chemically amplified positive working resist compositions. It is understood that the polymer of the invention may be admixed with another polymer for the purpose of altering the dynamic properties, thermal properties, alkali solubility and other physical properties of polymer film. The type of the other polymer which can be admixed is not critical, and any of polymers known to be useful in resist use may be admixed in any desired proportion.

Resist Composition

As long as the polymer of the invention is used as a base resin, the resist composition of the invention may be prepared using well-known components. In a preferred embodiment, the chemically amplified positive resist composition is defined as comprising (A) the above-defined polymer as a base resin, (B) an organic solvent, and (C) a photoacid generator. In the resist composition, there may be further formulated (D) a basic compound and/or (E) a dissolution inhibitor.

Component (B)

The organic solvent used as component (B) in the invention may be any organic solvent in which the base resin (inventive polymer), photoacid generator, and other components are soluble. Illustrative, non-limiting, examples of the organic solvent include ketones such as cyclohexanone and methyl-2-n-amylketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate.

These solvents may be used alone or in combinations of two or more thereof. Of the above organic solvents, preferred are diethylene glycol dimethyl ether and 1-ethoxy-2-propanol, in which the photoacid generator is most soluble, and propylene glycol monomethyl ether acetate (PGMEA) which is safe, and mixtures thereof.

The solvent is preferably used in an amount of about 300 to 10,000 parts by weight, more preferably about 500 to 5,000 parts by weight per 100 parts by weight of the base resin.

Component (C)

The photoacid generator is a compound capable of generating an acid upon exposure to high energy radiation or electron beams and includes the following:

(i) onium salts of the formula (P1a-1), (P1a-2) or (P1b),

(ii) diazomethane derivatives of the formula (P2),

(iii) glyoxime derivatives of the formula (P3),

(iv) bissulfone derivatives of the formula (P4),

(v) sulfonic acid esters of N-hydroxyimide compounds of the formula (P5),

(vi) β-ketosulfonic acid derivatives,

(vii) disulfone derivatives,

(viii) nitrobenzylsulfonate derivatives, and

(ix) sulfonate derivatives.

These photoacid generators are described in detail.
(i) Onium Salts of Formula (P1a-1), (P1a-2) or (P1b):

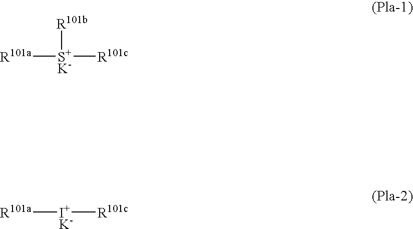

Herein, R^{101a}, R^{101b}, and R^{101c} independently represent straight, branched or cyclic alkyl, alkenyl, oxoalkyl or oxoalkenyl groups of 1 to 12 carbon atoms, aryl groups of 6 to 20 carbon atoms, or aralkyl or aryloxoalkyl groups of 7 to 12 carbon atoms, wherein some or all of the hydrogen atoms may be replaced by alkoxy or other groups. Also, R^{101b} and R^{101c}, taken together, may form a ring. R^{101b} and R^{101c} each are alkylene groups of 1 to 6 carbon atoms when they form a ring. K⁻ is a non-nucleophilic counter ion.

R^{101a}, R^{101b}, and R^{101c} may be the same or different and are illustrated below. Exemplary alkyl groups include methyl, ethyl, propyl, isopropyl, n-butyl, sec-butyl, tert-butyl, pentyl, hexyl, heptyl, octyl, cyclopentyl, cyclohexyl, cycloheptyl, cyclopropylmethyl, 4-methylcyclohexyl, cyclohexylmethyl, norbornyl, and adamantyl. Exemplary alkenyl groups include vinyl, allyl, propenyl, butenyl, hexenyl, and cyclohexenyl. Exemplary oxoalkyl groups include 2-oxocyclopentyl and 2-oxocyclohexyl as well as 2-oxopropyl, 2-cyclopentyl-2-oxoethyl, 2-cyclohexyl-2-oxoethyl, and 2-(4-methylcyclohexyl)-2-oxoethyl. Exemplary aryl groups include phenyl and naphthyl; alkoxyphenyl groups such as p-methoxyphenyl, m-methoxyphenyl, o-methoxyphenyl, ethoxyphenyl, p-tert-butoxyphenyl, and m-tert-butoxyphenyl; alkylphenyl groups such as 2-methylphenyl, 3-methylphenyl, 4-methylphenyl, ethylphenyl, 4-tert-butylphenyl, 4-butylphenyl, and dimethylphenyl; alkylnaphthyl groups such as methylnaphthyl and ethylnaphthyl; alkoxynaphthyl groups such as methoxynaphthyl and ethoxynaphthyl; dialkylnaphthyl groups such as dimethylnaphthyl and diethylnaphthyl; and dialkoxynaphthyl groups such as dimethoxynaphthyl and diethoxynaphthyl. Exemplary aralkyl groups include benzyl, phenylethyl, and phenethyl. Exemplary aryloxoalkyl groups are 2-aryl-2-oxoethyl groups such as 2-phenyl-2-oxoethyl, 2-(1-naphthyl)-2-oxoethyl, and 2-(2-naphthyl)-2-oxoethyl. Examples of the non-nucleophilic counter ion represented by K⁻ include halide ions such as chloride and bromide ions, fluoroalkylsulfonate ions such as triflate, 1,1,1-trifluoroethanesulfonate, and nonafluorobutanesulfonate, arylsulfonate ions such as tosylate, benzenesulfonate, 4-fluorobenzenesulfonate, and 1,2,3,4,5-pentafluorobenzenesulfonate, and alkylsulfonate ions such as mesylate and butanesulfonate.

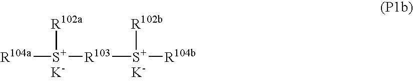

Herein, R^{102a} and R^{102b} independently represent straight, branched or cyclic alkyl groups of 1 to 8 carbon atoms. R¹⁰³ represents a straight, branched or cyclic alkylene group of 1 to 10 carbon atoms. R^{104a} and R^{104b} independently represent 2-oxoalkyl groups of 3 to 7 carbon atoms. K⁻ is a non-nucleophilic counter ion.

Illustrative of the groups represented by R^{102a} and R^{102b} are methyl, ethyl, propyl, isopropyl, n-butyl, sec-butyl, tert-butyl, pentyl, hexyl, heptyl, octyl, cyclopentyl, cyclohexyl, cyclopropylmethyl, 4-methylcyclohexyl, and cyclohexylmethyl. Illustrative of the groups represented by R¹⁰³ are methylene, ethylene, propylene, butylene, pentylene, hexylene, heptylene, octylene, nonylene, 1,4-cyclohexylene, 1,2-cyclohexylene, 1,3-cyclopentylene, 1,4-cyclooctylene, and 1,4-cyclohexanedimethylene. Illustrative of the groups represented by R^{104a} and R^{104b} are 2-oxopropyl, 2-oxocyclopentyl, 2-oxocyclohexyl, and 2-oxocycloheptyl. Illustrative examples of the counter ion represented by K⁻ are the same as exemplified for formulae (P1a-1) and (P1a-2).
(ii) Diazomethane Derivatives of Formula (P2)

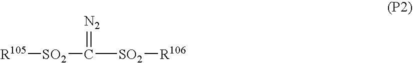

Herein, R¹⁰⁵ and R¹⁰⁶ independently represent straight, branched or cyclic alkyl or halogenated alkyl groups of 1 to 12 carbon atoms, aryl or halogenated aryl groups of 6 to 20 carbon atoms, or aralkyl groups of 7 to 12 carbon atoms.

Of the groups represented by R¹⁰⁵ and R¹⁰⁶, exemplary alkyl groups include methyl, ethyl, propyl, isopropyl, n-butyl, sec-butyl, tert-butyl, pentyl, hexyl, heptyl, octyl, amyl, cyclopentyl, cyclohexyl, cycloheptyl, norbornyl, and adamantyl. Exemplary halogenated alkyl groups include trifluoromethyl, 1,1,1-trifluoroethyl, 1,1,1-trichloroethyl, and nonafluorobutyl. Exemplary aryl groups include phenyl;

alkoxyphenyl groups such as p-methoxyphenyl, m-methoxyphenyl, o-methoxyphenyl, ethoxyphenyl, p-tert-butoxyphenyl, and m-tert-butoxyphenyl; and alkylphenyl groups such as 2-methylphenyl, 3-methylphenyl, 4-methylphenyl, ethylphenyl, 4-tert-butylphenyl, 4-butylphenyl, and dimethylphenyl. Exemplary halogenated aryl groups include fluorophenyl, chlorophenyl, and 1,2,3,4,5-pentafluorophenyl. Exemplary aralkyl groups include benzyl and phenethyl.
(iii) Glyoxime Derivatives of Formula (P3)

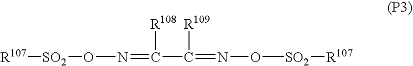

Herein, R¹⁰⁷, R¹⁰⁸, and R¹⁰⁹ independently represent straight, branched or cyclic alkyl or halogenated alkyl groups of 1 to 12 carbon atoms, aryl or halogenated aryl groups of 6 to 20 carbon atoms, or aralkyl groups of 7 to 12 carbon atoms. Also, R¹⁰⁸ and R¹⁰⁹, taken together, may form a ring. R¹⁰⁸ and R¹⁰⁹ each are straight or branched alkylene groups of 1 to 6 carbon atoms when they form a ring.

Illustrative examples of the alkyl, halogenated alkyl, aryl, halogenated aryl, and aralkyl groups represented by R¹⁰⁷, R¹⁰⁸, and R¹⁰⁹ are the same as exemplified for R¹⁰⁵ and R¹⁰⁶. Examples of the alkylene groups represented by R¹⁰⁸ and R¹⁰⁹ include methylene, ethylene, propylene, butylene, and hexylene.
(iv) Bissulfone Derivatives of Formula (P4)

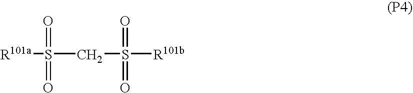

Herein, R^{101a} and R^{101b} are as defined above.
(v) Sulfonic Acid Esters of N-Hydroxyimide Compounds of Formula (P5)

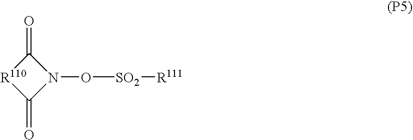

Herein, R¹¹⁰ is an arylene group of 6 to 10 carbon atoms, alkylene group of 1 to 6 carbon atoms, or alkenylene group of 2 to 6 carbon atoms wherein some or all of the hydrogen atoms may be replaced by straight or branched alkyl or alkoxy groups of 1 to 4 carbon atoms, nitro, acetyl, or phenyl groups. R¹¹¹ is a straight, branched or cyclic alkyl group of 1 to 8 carbon atoms, alkenyl, alkoxyalkyl, phenyl or naphthyl group wherein some or all of the hydrogen atoms may be replaced by alkyl or alkoxy groups of 1 to 4 carbon atoms, phenyl groups (which may have substituted thereon an alkyl or alkoxy of 1 to 4 carbon atoms, nitro, or acetyl group), hetero-aromatic groups of 3 to 5 carbon atoms, or chlorine or fluorine atoms.

Of the groups represented by R¹¹⁰, exemplary arylene groups include 1,2-phenylene and 1,8-naphthylene; exemplary alkylene groups include methylene, ethylene, trimethylene, tetramethylene, phenylethylene, and norbornane-2,3-diyl; and exemplary alkenylene groups include 1,2-vinylene, 1-phenyl-1,2-vinylene, and 5-norbornene-2,3-diyl. Of the groups represented by R¹¹¹, exemplary alkyl groups are as exemplified for R^{101a} to R^{101c}; exemplary alkenyl groups include vinyl, 1-propenyl, allyl, 1-butenyl, 3-butenyl, isoprenyl, 1-pentenyl, 3-pentenyl, 4-pentenyl, dimethylallyl, 1-hexenyl, 3-hexenyl, 5-hexenyl, 1-heptenyl, 3-heptenyl, 6-heptenyl, and 7-octenyl; and exemplary alkoxyalkyl groups include methoxymethyl, ethoxymethyl, propoxymethyl, butoxymethyl, pentyloxymethyl, hexyloxymethyl, heptyloxymethyl, methoxyethyl, ethoxyethyl, propoxyethyl, butoxyethyl, pentyloxyethyl, hexyloxyethyl, methoxypropyl, ethoxypropyl, propoxypropyl, butoxypropyl, methoxybutyl, ethoxybutyl, propoxybutyl, methoxypentyl, ethoxypentyl, methoxyhexyl, and methoxyheptyl.

Of the substituents on these groups, the alkyl groups of 1 to 4 carbon atoms include methyl, ethyl, propyl, isopropyl, n-butyl, isobutyl and tert-butyl; and the alkoxy groups of 1 to 4 carbon atoms include methoxy, ethoxy, propoxy, isopropoxy, n-butoxy, isobutoxy, and tert-butoxy. The phenyl groups which may have substituted thereon an alkyl or alkoxy of 1 to 4 carbon atoms, nitro, or acetyl group include phenyl, tolyl, p-tert-butoxyphenyl, p-acetylphenyl and p-nitrophenyl. The hetero-aromatic groups of 3 to 5 carbon atoms include pyridyl and furyl.

Illustrative examples of the photoacid generator include:

onium salts such as diphenyliodonium trifluoromethanesulfonate, (p-tert-butoxyphenyl)phenyliodonium trifluoromethanesulfonate, diphenyliodonium p-toluenesulfonate, (p-tert-butoxyphenyl)phenyliodonium p-toluenesulfonate, triphenylsulfonium trifluoromethanesulfonate, (p-tert-butoxyphenyl)diphenylsulfonium trifluoromethane-sulfonate, bis(p-tert-butoxyphenyl)phenylsulfonium trifluoromethane-sulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, bis(p-tert-butoxyphenyl)phenylsulfonium p-toluenesulfonate, tris(p-tert-butoxyphenyl)sulfonium p-toluenesulfonate, triphenylsulfonium nonafluorobutanesulfonate, triphenylsulfonium butanesulfonate, trimethylsulfonium trifluoromethanesulfonate, trimethylsulfonium p-toluenesulfonate, cyclohexylmethyl(2-oxocyclohexyl)sulfonium trifluoromethane-sulfonate, cyclohexylmethyl(2-oxocyclohexyl)sulfonium p-toluenesulfonate, dimethylphenylsulfonium trifluoromethanesulfonate, dimethylphenylsulfonium p-toluenesulfonate, dicyclohexylphenylsulfonium trifluoromethanesulfonate, dicyclohexylphenylsulfonium p-toluenesulfonate, trinaphthylsulfonium trifluoromethanesulfonate, cyclohexylmethyl(2-oxocyclohexyl)sulfonium trifluoromethane-sulfonate, (2-norbornyl)methyl(2-oxocyclohexyl)sulfonium trifluoro-methanesulfonate, ethylenebis[methyl(2-oxocyclopentyl)sulfonium trifluoro-methanesulfonate], and 1,2′-naphthylcarbonylmethyltetrahydrothiophenium triflate;

diazomethane derivatives such as bis(benzenesulfonyl)diazomethane, bis(p-toluenesulfonyl)diazomethane, bis(xylenesulfonyl)diazomethane, bis(cyclohexylsulfonyl)diazomethane, bis(cyclopentylsulfonyl)diazomethane, bis(n-butylsulfonyl)diazomethane, bis(isobutylsulfonyl)diazomethane, bis(sec-butylsulfonyl)diazomethane, bis(n-propylsulfonyl)diazomethane, bis(isopropylsulfonyl)diazomethane, bis(tert-butylsulfonyl)diazomethane, bis(n-amylsulfonyl)diazomethane, bis(isoamylsulfonyl)diazomethane, bis(sec-amylsulfonyl)diazomethane, bis(tert-amylsulfonyl)diazomethane, 1-cyclohexylsulfonyl-1-(tert-butylsulfonyl)diazomethane, 1-cyclohexylsulfonyl-1-(tert-amylsulfonyl)diazomethane, and 1-tert-amylsulfonyl-1-(tert-butylsulfonyl)diazomethane;

glyoxime derivatives such as bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-O-(p-toluenesulfonyl)-2-methyl-3,4-pentanedioneglyoxime, bis-O-(n-butanesulfonyl)-α-dimethylglyoxime, bis-O-(n-butanesulfonyl)-α-diphenylglyoxime, bis-O-(n-butanesulfonyl)-α-dicyclohexylglyoxime, bis-O-(n-butanesulfonyl)-2,3-pentanedioneglyoxime, bis-O-(n-butanesulfonyl)-2-methyl-3,4-pentanedioneglyoxime, bis-O-(methanesulfonyl)-α-dimethylglyoxime, bis-O-(trifluoromethanesulfonyl)-α-dimethylglyoxime, bis-O-(1,1,1-trifluoroethanesulfonyl)-α-dimethylglyoxime, bis-O-(tert-butanesulfonyl)-α-dimethylglyoxime, bis-O-(perfluorooctanesulfonyl)-α-dimethylglyoxime, bis-O-(cyclohexanesulfonyl)-α-dimethylglyoxime, bis-O-(benzenesulfonyl)-α-dimethylglyoxime, bis-O-(p-fluorobenzenesulfonyl)-α-dimethylglyoxime, bis-O-(p-tert-butylbenzenesulfonyl)-α-dimethylglyoxime, bis-O-(xylenesulfonyl)-α-dimethylglyoxime, and bis-O-(camphorsulfonyl)-α-dimethylglyoxime;

bissulfone derivatives such as bisnaphthylsulfonylmethane, bistrifluoromethylsulfonylmethane, bismethylsulfonylmethane, bisethylsulfonylmethane, bispropylsulfonylmethane, bisisopropylsulfonylmethane, bis-p-toluenesulfonylmethane, and bisbenzenesulfonylmethane;

β-ketosulfone derivatives such as 2-cyclohexylcarbonyl-2-(p-toluenesulfonyl)propane and 2-isopropylcarbonyl-2-(p-toluenesulfonyl)propane;

nitrobenzyl sulfonate derivatives such as 2,6-dinitrobenzyl p-toluenesulfonate and 2,4-dinitrobenzyl p-toluenesulfonate;

sulfonic acid ester derivatives such as 1,2,3-tris(methanesulfonyloxy)benzene, 1,2,3-tris(trifluoromethanesulfonyloxy)benzene, and 1,2,3-tris(p-toluenesulfonyloxy)benzene; and

sulfonic acid esters of N-hydroxyimides such as N-hydroxysuccinimide methanesulfonate, N-hydroxysuccinimide trifluoromethanesulfonate, N-hydroxysuccinimide ethanesulfonate, N-hydroxysuccinimide 1-propanesulfonate, N-hydroxysuccinimide 2-propanesulfonate, N-hydroxysuccinimide 1-pentanesulfonate, N-hydroxysuccinimide 1-octanesulfonate, N-hydroxysuccinimide p-toluenesulfonate, N-hydroxysuccinimide p-methoxybenzenesulfonate, N-hydroxysuccinimide 2-chloroethanesulfonate, N-hydroxysuccinimide benzenesulfonate, N-hydroxysuccinimide 2,4,6-trimethylbenzenesulfonate, N-hydroxysuccinimide 1-naphthalenesulfonate, N-hydroxysuccinimide 2-naphthalenesulfonate, N-hydroxy-2-phenylsuccinimide methanesulfonate, N-hydroxymaleimide methanesulfonate, N-hydroxymaleimide ethanesulfonate, N-hydroxy-2-phenylmaleimide methanesulfonate, N-hydroxyglutarimide methanesulfonate, N-hydroxyglutarimide benzenesulfonate, N-hydroxyphthalimide methanesulfonate, N-hydroxyphthalimide benzenesulfonate, N-hydroxyphthalimide trifluoromethanesulfonate, N-hydroxyphthalimide p-toluenesulfonate, N-hydroxynaphthalimide methanesulfonate, N-hydroxynaphthalimide benzenesulfonate, N-hydroxy-5-norbornene-2,3-dicarboxyimide methanesulfonate, N-hydroxy-5-norbornene-2,3-dicarboxyimide trifluoromethane-sulfonate, and N-hydroxy-5-norbornene-2,3-dicarboxyimide p-toluenesulfonate.

Preferred among these photoacid generators are onium salts such as triphenylsulfonium trifluoromethanesulfonate, (p-tert-butoxyphenyl)diphenylsulfonium trifluoromethane-sulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, tris(p-tert-butoxyphenyl)sulfonium p-toluenesulfonate, trinaphthylsulfonium trifluoromethanesulfonate, cyclohexylmethyl(2-oxocyclohexyl)sulfonium trifluoromethane-sulfonate, (2-norbornyl)methyl(2-oxocylohexyl)sulfonium trifluoro-methanesulfonate, and 1,2′-naphthylcarbonylmethyltetrahydrothiophenium triflate; diazomethane derivatives such as bis(benzenesulfonyl)diazomethane, bis(p-toluenesulfonyl)diazomethane, bis(cyclohexylsulfonyl)diazomethane, bis(n-butylsulfonyl)diazomethane, bis(isobutylsulfonyl)diazomethane, bis(sec-butylsulfonyl)diazomethane, bis(n-propylsulfonyl)diazomethane, bis(isopropylsulfonyl)diazomethane, and bis(tert-butylsulfonyl)diazomethane; glyoxime derivatives such as bis-O-(p-toluenesulfonyl)-α-dimethylglyoxime and bis-O-(n-butanesulfonyl)-α-dimethylglyoxime; bissulfone derivatives such as bisnaphthylsulfonylmethane; and sulfonic acid esters of N-hydroxyimide compounds such as N-hydroxysuccinimide methanesulfonate, N-hydroxysuccinimide trifluoromethanesulfonate, N-hydroxysuccinimide 1-propanesulfonate, N-hydroxysuccinimide 2-propanesulfonate, N-hydroxysuccinimide 1-pentanesulfonate, N-hydroxysuccinimide p-toluenesulfonate, N-hydroxynaphthalimide methanesulfonate, and N-hydroxynaphthalimide benzenesulfonate.

These photoacid generators may be used singly or in combinations of two or more thereof. Onium salts are effective for improving rectangularity, while diazomethane derivatives and glyoxime derivatives are effective for reducing standing waves. The combination of an onium salt with a diazomethane or a glyoxime derivative allows for fine adjustment of the profile.

The photoacid generator is added in an amount of 0.1 to 50 parts, and especially 0.5 to 40 parts by weight, per 100 parts by weight of the base resin. Less than 0.1 part of the photoacid generator may generate a less amount of acid upon exposure, sometimes leading to a poor sensitivity and resolution whereas more than 50 parts of the photoacid generator may adversely affect the transmittance and resolution of resist.

Component (D)

The basic compound used as component (D) is preferably a compound capable of suppressing the rate of diffusion when the acid generated by the photoacid generator diffuses within the resist film. The inclusion of this type of basic compound holds down the rate of acid diffusion within the resist film, resulting in better resolution. In addition, it suppresses changes in sensitivity following exposure, thus reducing substrate and environment dependence, as well as improving the exposure latitude and the pattern profile.

Examples of suitable basic compounds include primary, secondary, and tertiary aliphatic amines, mixed amines, aromatic amines, heterocyclic amines, nitrogen-containing compounds having carboxyl group, nitrogen-containing compounds having sulfonyl group, nitrogen-containing compounds having hydroxyl group, nitrogen-containing compounds having hydroxyphenyl group, nitrogen-containing alcoholic compounds, amide derivatives, and imide derivatives.

Examples of suitable primary aliphatic amines include ammonia, methylamine, ethylamine, n-propylamine, isopropylamine, n-butylamine, iso-butylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, and tetraethylenepentamine. Examples of suitable secondary aliphatic amines include dimethylamine, diethylamine, di-n-propylamine, di-iso-propylamine, di-n-butylamine, di-iso-butylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine. Examples of suitable tertiary aliphatic amines include trimethylamine, triethylamine, tri-n-propylamine, tri-iso-propylamine, tri-n-butylamine, tri-iso-butylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine.

Examples of suitable mixed amines include dimethylethylamine, methylethylpropylamine, benzylamine, phenethylamine, and benzyldimethylamine. Examples of suitable aromatic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, and diaminonaphthalene. Examples of suitable heterocyclic amines include pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 4-pyrrolidinopyridine, 1-methyl-4-phenylpyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, and uridine derivatives.

Examples of suitable nitrogen-containing compounds having carboxyl group include aminobenzoic acid, indolecarboxylic acid, and amino acid derivatives (e.g., nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine). Examples of suitable nitrogen-containing compounds having sulfonyl group include 3-pyridinesulfonic acid and pyridinium p-toluenesulfonate. Examples of suitable nitrogen-containing compounds having hydroxyl group, nitrogen-containing compounds having hydroxyphenyl group, and nitrogen-containing alcoholic compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl)phthalimide, and N-(2-hydroxyethyl)isonicotinamide. Examples of suitable amide derivatives include formamide, N-methylformamide, N,N-dimethylformamide, acetamide, N-methylacetamide, N,N-dimethylacetamide, propionamide, and benzamide. Suitable imide derivatives include phthalimide, succinimide, and maleimide.

One or more basic compounds of the following general formula (B)-1 may also be added.

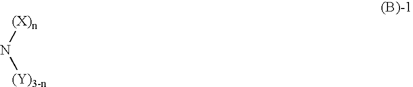

In the formula, n is equal to 1, 2 or 3; side chain Y is independently hydrogen or a straight, branched or cyclic alkyl group of 1 to 20 carbon atoms which may contain an ether or hydroxyl group; and side chain X is independently selected from groups of the following general formulas (X)-1 to (X)-3, and two or three X's may bond together to form a ring.

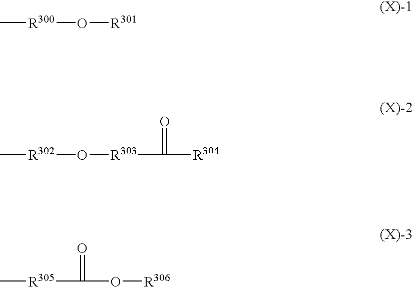

In the formulas, R³⁰⁰, R³⁰² and R³⁰⁵ are independently straight or branched alkylene groups of 1 to 4 carbon atoms; R³⁰¹ and R³⁰⁴ are independently hydrogen, straight, branched or cyclic alkyl groups of 1 to 20 carbon atoms, which may contain at least one hydroxyl, ether, ester group or lactone ring; R³⁰³ is a single bond or a straight or branched alkylene group of 1 to 4 carbon atoms; and R³⁰⁶ is hydrogen or a straight, branched or cyclic alkyl group of 1 to 20 carbon atoms, which may contain at least one hydroxyl, ether, ester group or lactone ring.

Illustrative examples of the compounds of formula (B)-1 include tris(2-methoxymethoxyethyl)amine, tris{2-(2-methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxypropoxy)ethyl}amine, tris[2-{2-(2-hydroxyethoxy)ethoxy}ethyl]amine, 4,7,13,16,21,24-hexaoxa-1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4,1-aza-15-crown-5, 1-aza-18-crown-6, tris(2-formyloxyethyl)amine, tris(2-acetoxyethyl)amine, tris(2-propionyloxyethyl)amine, tris(2-butyryloxyethyl)amine, tris(2-isobutyryloxyethyl)amine, tris(2-valeryloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-methoxycarbonylethyl)amine, tris(2-ethoxycarbonylethyl)amine, N,N-bis(2-hydroxyethyl)-2-(methoxycarbonyl)ethylamine, N,N-bis(2-acetoxyethyl)-2-(methoxycarbonyl)ethylamine, N,N-bis(2-hydroxyethyl)-2-(ethoxycarbonyl)ethylamine, N,N-bis(2-acetoxyethyl)-2-(ethoxycarbonyl)ethylamine, N,N-bis(2-hydroxyethyl)-2-(2-methoxyethoxycarbonyl)ethylamine, N,N-bis(2-acetoxyethyl)-2-(2-methoxyethoxycarbonyl)ethylamine, N,N-bis(2-hydroxyethyl)-2-(2-hydroxyethoxycarbonyl)ethylamine, N,N-bis(2-acetoxyethyl)-2-(2-acetoxyethoxycarbonyl)ethylamine, N,N-bis(2-hydroxyethyl)-2-[(methoxycarbonyl)methoxycarbonyl]-thylamine, N,N-bis(2-acetoxyethyl)-2-[(methoxycarbonyl)methoxycarbonyl]-thylamine, N,N-bis(2-hydroxyethyl)-2-(2-oxopropoxycarbonyl)ethylamine, N,N-bis(2-acetoxyethyl)-2-(2-oxopropoxycarbonyl)ethylamine, N,N-bis(2-hydroxyethyl)-2-(tetrahydrofurfuryloxycarbonyl)-ethylamine, N,N-bis(2-acetoxyethyl)-2-(tetrahydrofurfuryloxycarbonyl)-ethylamine, N,N-bis(2-hydroxyethyl)-2-[(2-oxotetrahydrofuran-3-yl)oxy-carbonyl]ethylamine, N,N-bis(2-acetoxyethyl)-2-[(2-oxotetrahydrofuran-3-yl)oxy-carbonyl]ethylamine, N,N-bis(2-hydroxyethyl)-2-(4-hydroxybutoxycarbonyl)ethylamine, N,N-bis(2-formyloxyethyl)-2-(4-formyloxybutoxycarbonyl)-ethylamine, N,N-bis(2-formyloxyethyl)-2-(2-formyloxyethoxycarbonyl)-ethylamine, N,N-bis(2-methoxyethyl)-2-(methoxycarbonyl)ethylamine, N-(2-hydroxyethyl)-bis[2-(methoxycarbonyl)ethyl]amine, N-(2-acetoxyethyl)-bis[2-(methoxycarbonyl)ethyl]amine, N-(2-hydroxyethyl)-bis[2-(ethoxycarbonyl)ethyl]amine, N-(2-acetoxyethyl)-bis[2-(ethoxycarbonyl)ethyl]amine, N-(3-hydroxy-1-propyl)-bis[2-(methoxycarbonyl)ethyl]amine, N-(3-acetoxy-1-propyl)-bis[2-(methoxycarbonyl)ethyl]amine, N-(2-methoxyethyl)-bis[2-(methoxycarbonyl)ethyl]amine, N-butyl-bis[2-(methoxycarbonyl)ethyl]amine, N-butyl-bis[2-(2-methoxyethoxycarbonyl)ethyl]amine, N-methyl-bis(2-acetoxyethyl)amine, N-ethyl-bis(2-acetoxyethyl)amine, N-methyl-bis(2-pivaloyloxyethyl)amine, N-ethyl-bis[2-(methoxycarbonyloxy)ethyl]amine, N-ethyl-bis[2-(tert-butoxycarbonyloxy)ethyl]amine, tris(methoxycarbonylmethyl)amine, tris(ethoxycarbonylmethyl)amine, N-butyl-bis(methoxycarbonylmethyl)amine, N-hexyl-bis(methoxycarbonylmethyl)amine, and β-(diethylamino)-δ-valerolactone.

Also useful are basic compounds having cyclic structure, represented by the following general formula (B)-2. 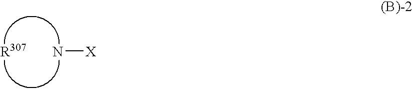
Herein X is as defined above, and R³⁰⁷ is a straight or branched alkylene group of 2 to 20 carbon atoms which may contain one or more carbonyl, ether, ester or sulfide groups.

Illustrative examples of the compounds having formula (B)-2 include 1-[2-(methoxymethoxy)ethyl]pyrrolidine, 1-[2-(methoxymethoxy)ethyl]piperidine, 4-[2-(methoxymethoxy)ethyl]morpholine, 1-[2-[(2-methoxyethoxy)methoxy]ethyl]pyrrolidine, 1-[2-[(2-methoxyethoxy)methoxy]ethyl]piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxyacetate, 2-(1-pyrrolidinyl)ethyl methoxyacetate, 4-[2-(methoxycarbonyloxy)ethyl]morpholine, 1-[2-(t-butoxycarbonyloxy)ethyl]piperidine, 4-[2-(2-methoxyethoxycarbonyloxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholinopropionate, glycidyl 3-piperidinopropionate, 2-methoxyethyl 3-morpholinopropionate, 2-(2-methoxyethoxy)ethyl 3-(1-pyrrolidinyl)propionate, butyl 3-morpholinopropionate, cyclohexyl 3-piperidinopropionate, α-(1-pyrrolidinyl)methyl-γ-butyrolactone, β-piperidino-γ-butyrolactone, β-morpholino-δ-valerolactone, ethyl 1-pyrrolidinylacetate, methyl piperidinoacetate, methyl morpholinoacetate, methyl thiomorpholinoacetate, ethyl 1-pyrrolidinylacetate, and 2-methoxyethyl morpholinoacetate.

Also, basic compounds having cyano group, represented by the following general formulae (B)-3 to (B)-6 are useful. 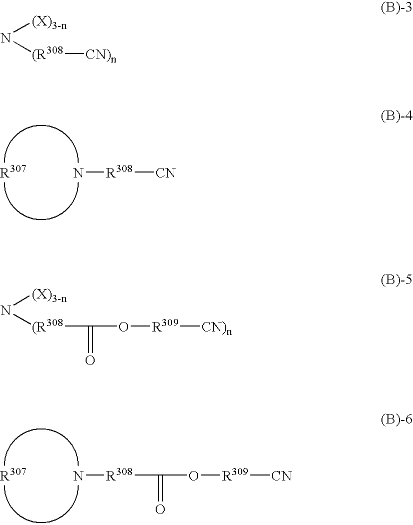
Herein, X, R³⁰⁷ and n are as defined above, and R³⁰⁸ and R³⁰⁹ are each independently a straight or branched alkylene group of 1 to 4 carbon atoms.

Illustrative examples of the basic compounds having cyano group, represented by formulae (B)-3 to (B)-6, include 3-(diethylamino)propiononitrile, N,N-bis(2-hydroxyethyl)-3-aminopropiononitrile, N,N-bis(2-acetoxyethyl)-3-aminopropiononitrile, N,N-bis(2-formyloxyethyl)-3-aminopropiononitrile, N,N-bis(2-methoxyethyl)-3-aminopropiononitrile, N,N-bis[2-(methoxymethoxy)ethyl]-3-aminopropiononitrile, methyl N-(2-cyanoethyl)-N-(2-methoxyethyl)-3-aminopropionate, methyl N-(2-cyanoethyl)-N-(2-hydroxyethyl)-3-aminopropionate, methyl N-(2-acetoxyethyl)-N-(2-cyanoethyl)-3-aminopropionate, N-(2-cyanoethyl)-N-ethyl-3-aminopropiononitrile, N-(2-cyanoethyl)-N-(2-hydroxyethyl)-3-aminopropiononitrile, N-(2-acetoxyethyl)-N-(2-cyanoethyl)-3-aminopropiononitrile, N-(2-cyanoethyl)-N-(2-formyloxyethyl)-3-aminopropiononitrile, N-(2-cyanoethyl)-N-(2-methoxyethyl)-3-aminopropiononitrile, N-(2-cyanoethyl)-N-[2-(methoxymethoxy)ethyl]-3-aminopropiono-nitrile, N-(2-cyanoethyl)-N-(3-hydroxy-1-propyl)-3-aminopropiononitrile, N-(3-acetoxy-1-propyl)-N-(2-cyanoethyl)-3-aminopropiononitrile, N-(2-cyanoethyl)-N-(3-formyloxy-1-propyl)-3-aminopropiono-nitrile, N-(2-cyanoethyl)-N-tetrahydrofurfuryl-3-aminopropiononitrile, N,N-bis(2-cyanoethyl)-3-aminopropiononitrile, diethylaminoacetonitrile, N,N-bis(2-hydroxyethyl)aminoacetonitrile, N,N-bis(2-acetoxyethyl)aminoacetonitrile, N,N-bis(2-formyloxyethyl)aminoacetonitrile, N,N-bis(2-methoxyethyl)aminoacetonitrile, N,N-bis[2-(methoxymethoxy)ethyl]aminoacetonitrile, methyl N-cyanomethyl-N-(2-methoxyethyl)-3-aminopropionate, methyl N-cyanomethyl-N-(2-hydroxyethyl)-3-aminopropionate, methyl N-(2-acetoxyethyl)-N-cyanomethyl-3-aminopropionate, N-cyanomethyl-N-(2-hydroxyethyl)aminoacetonitrile, N-(2-acetoxyethyl)-N-(cyanomethyl)aminoacetonitrile, N-cyanomethyl-N-(2-formyloxyethyl)aminoacetonitrile, N-cyanomethyl-N-(2-methoxyethyl)aminoacetonitrile, N-cyanomethyl-N-[2-(methoxymethoxy)ethyl]aminoacetonitrile, N-cyanomethyl-N-(3-hydroxy-1-propyl)aminoacetonitrile, N-(3-acetoxy-1-propyl)-N-(cyanomethyl)aminoacetonitrile, N-cyanomethyl-N-(3-formyloxy-1-propyl)aminoacetonitrile, N,N-bis(cyanomethyl)aminoacetonitrile, 1-pyrrolidinepropiononitrile, 1-piperidinepropiononitrile, 4-morpholinepropiononitrile, 1-pyrrolidineacetonitrile, 1-piperidineacetonitrile, 4-morpholineacetonitrile, cyanomethyl 3-diethylaminopropionate, cyanomethyl N,N-bis(2-hydroxyethyl)-3-aminopropionate, cyanomethyl N,N-bis(2-acetoxyethyl)-3-aminopropionate, cyanomethyl N,N-bis(2-formyloxyethyl)-3-aminopropionate, cyanomethyl N,N-bis(2-methoxyethyl)-3-aminopropionate, cyanomethyl N,N-bis[2-(methoxymethoxy)ethyl]-3-aminopropionate, 2-cyanoethyl 3-diethylaminopropionate, 2-cyanoethyl N,N-bis(2-hydroxyethyl)-3-aminopropionate, 2-cyanoethyl N,N-bis(2-acetoxyethyl)-3-aminopropionate, 2-cyanoethyl N,N-bist(2-formyloxyethyl)-3-aminopropionate, 2-cyanoethyl N,N-bis(2-methoxyethyl)-3-aminopropionate, 2-cyanoethyl N,N-bis[2-(methoxymethoxy)ethyl]-3-aminopropionate, cyanomethyl 1-pyrrolidinepropionate, cyanomethyl 1-piperidinepropionate, cyanomethyl 4-morpholinepropionate, 2-cyanoethyl 1-pyrrolidinepropionate, 2-cyanoethyl 1-piperidinepropionate, and 2-cyanoethyl 4-morpholinepropionate.

Also included are nitrogen-containing organic compounds having an imidazole structure and a polar functional group, represented by the following general formula (B)-7. 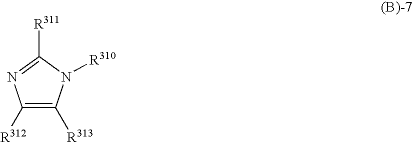
Herein, R³¹⁰ is a straight, branched or cyclic C₂-C₂₀ alkyl group having at least one polar functional group selected from among hydroxyl, carbonyl, ester, ether, sulfide, carbonate, cyano and acetal groups; R³¹¹, R³¹² and R³¹³ are each independently a hydrogen atom, a straight, branched or cyclic alkyl group, aryl group or aralkyl group having 1 to 10 carbon atoms.

Also included are nitrogen-containing organic compounds having a benzimidazole structure and a polar functional group, represented by the general formula (B)-8. 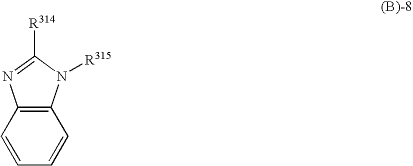
Herein, R³¹⁴ is a hydrogen atom, a straight, branched or cyclic alkyl group, aryl group or aralkyl group having 1 to 10 carbon atoms. R³¹⁵ is a polar functional group-bearing, straight, branched or cyclic C₁-C₂₀ alkyl group, and the alkyl group contains as the polar functional group at least one group selected from among ester, acetal and cyano groups, and may additionally contain at least one group selected from among hydroxyl, carbonyl, ether, sulfide and.carbonate groups.

Further included are heterocyclic nitrogen-containing compounds having a polar functional group, represented by the general formulae (B)-9 and (B)-10. 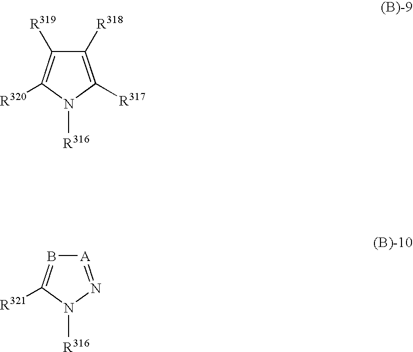
Herein, A is a nitrogen atom or ≡C—R³²², B is a nitrogen atom or ≡C—R³²³, R³¹⁶ is a straight, branched or cyclic C₂-C₂₀ alkyl group having at least one polar functional group selected from among hydroxyl, carbonyl, ester, ether, sulfide, carbonate, cyano and acetal groups; R³¹⁷, R³¹⁸, R³¹⁹ and R³²⁰ are each independently a hydrogen atom, a straight, branched or cyclic alkyl group or aryl group having 1 to 10 carbon atoms, or a pair of R³¹⁷ and R³¹⁸ and a pair of R³¹⁹ and R³²⁰ taken together, may form a benzene, naphthalene or pyridine ring; R³²¹ is a hydrogen atom, a straight, branched or cyclic alkyl group or aryl group having 1 to 10 carbon atoms; R³²² and R³²³ each are a hydrogen atom, a straight, branched or cyclic alkyl group or aryl group having 1 to 10 carbon atoms, or a pair of R³²¹ and R³²³, taken together, may form a benzene or naphthalene ring.

The basic compound is preferably formulated in an amount of 0.001 to 2 parts, and especially 0.01 to 1 part by weight, per 100 parts by weight of the entire base resin. Less than 0.001 part of the basic compound achieves no or little addition effect whereas more than 2 parts would result in too low a sensitivity.

Component (E)

The dissolution inhibitor (E) is a compound with a weight average molecular weight of up to 3,000 which changes its solubility in an alkaline developer under the action of an acid, and typically selected from phenol and carboxylic acid derivatives in which some or all of hydroxyl groups are substituted with acid labile groups (as described above) and which have a weight average molecular weight of up to 2,500.

Examples of the phenol or carboxylic acid derivative having a weight average molecular weight of up to 2,500 include 4,4′-(1-methylethylidene)bisphenol, (1,1′-biphenyl-4,4′-diol)-2,2′-methylenebis(4-methylphenol), 4,4-bis(4′-hydroxyphenyl)valeric acid, tris(4-hydroxyphenyl)methane, 1,1,1-tris(4′-hydroxyphenyl)ethane, 1,1,2-tris(4′-hydroxyphenyl)ethane, phenolphthalein, thimolphthalein, 3,3′-difluoro[(1,1′-biphenyl)-4,4′-diol], 3,3′,5,5′-tetrafluoro[(1,1′-biphenyl)-4,4′-diol], 4,4′-[2,2,2-trifluoro-1-(trifluoromethyl)ethylidene]bisphenol, 4,4′-methylenebis(2-fluorophenol), 2,2′-methylenebis(4-fluorophenol), 4,41-isopropylidenebis(2-fluorophenol), cyclohexylidenebis(2-fluorophenol), 4,4′-[(4-fluorophenyl)methylene]bis(2-fluorophenol), 4,4′-methylenebis(2,6-difluorophenol), 4,4′-(4-fluorophenyl)methylenebis(2,6-difluorophenol), 2,6-bis[(2-hydroxy-5-fluorophenyl)methyl]-4-fluorophenol, 2,6-bis[(4-hydroxy-3-fluorophenyl)methyl]-4-fluorophenol, and 2,4-bis[(3-hydroxy-4-hydroxyphenyl)methyl]-6-methylphenol. The acid labile groups are the same as formulae (AL-1) to (AL-3) described above.

Illustrative, non-limiting, examples of the dissolution inhibitors which are useful herein include 3,3′,5,5′-tetrafluoro[(1,1′-biphenyl)-4,4′-di-t-butoxycarbonyl], 4,4′-[2,2,2-trifluoro-1-(trifluoromethyl)ethylidene]-bisphenol-4,4′-di-t-butoxycarbonyl, bis(4-(2′-tetrahydropyranyloxy)phenyl)methane, bis(4-(2′-tetrahydrofuranyloxy)phenyl)methane, bis(4-tert-butoxyphenyl)methane, bis(4-tert-butoxycarbonyloxyphenyl)methane, bis(4-tert-butoxycarbonylmethyloxyphenyl)methane, bis(4-(1′-ethoxyethoxy)phenyl)methane, bis(4-(1′-ethoxypropyloxy)phenyl)methane, 2,2-bis(4′-(2″-tetrahydropyranyloxy))propane, 2,2-bis(4′-(2″-tetrahydrofuranyloxy)phenyl)propane, 2,2-bis(4′-tert-butoxyphenyl)propane, 2,2-bis(4′-tert-butoxycarbonyloxyphenyl)propane, 2,2-bis(4-tert-butoxycarbonylmethyloxyphenyl)propane, 2,2-bis(4′-(1″-ethoxyethoxy)phenyl)propane, 2,2-bis(4′-(1″-ethoxypropyloxy)phenyl)propane, tert-butyl 4,4-bis(4′-(2″-tetrahydropyranyloxy)phenyl)valerate, tert-butyl 4,4-bis(41-(2″-tetrahydrofuranyloxy)phenyl)valerate, tert-butyl 4,4-bis(4′-tert-butoxyphenyl)valerate, tert-butyl 4,4-bis(4-tert-butoxycarbonyloxyphenyl)valerate, tert-butyl 4,4-bis(4′-tert-butoxycarbonylmethyloxyphenyl)-valerate, tert-butyl 4,4-bis(4′-(1″-ethoxyethoxy)phenyl)valerate, tert-butyl 4,4-bis(41-(l1′-ethoxypropyloxy)phenyl)valerate, tris(4-(2′-tetrahydropyranyloxy)phenyl)methane, tris(4-(21-tetrahydrofuranyloxy)phenyl)methane, tris(4-tert-butoxyphenyl)methane, tris(4-tert-butoxycarbonyloxyphenyl)methane, tris(4-tert-butoxycarbonyloxymethylphenyl)methane, tris(4-(1l′-ethoxyethoxy)phenyl)methane, tris(4-(1l′-ethoxypropyloxy)phenyl)methane, 1,1,2-tris(4′-(2″-tetrahydropyranyloxy)phenyl)ethane, 1,1,2-tris(4′-(2″-tetrahydrofuranyloxy)phenyl)ethane, 1,1,2-tris(41-tert-butoxyphenyl)ethane, 1,1,2-tris(4′-tert-butoxycarbonyloxyphenyl)ethane, 1,1,2-tris(4′-tert-butoxycarbonylmethyloxyphenyl)ethane, 1,1,2-tris(4′-(1′-ethoxyethoxy)phenyl)ethane, 1,1,2-tris(4′-(1′-ethoxypropyloxy)phenyl)ethane, t-butyl 2-trifluoromethylbenzenecarboxylate, t-butyl 2-trifluoromethylcyclohexanecarboxylate, t-butyl decahydronaphthalene-2,6-dicarboxylate, t-butyl cholate, t-butyl deoxycholate, t-butyl adamantanecarboxylate, t-butyl adamantaneacetate, and tetra-t-butyl 1,1′-bicyclohexyl-3,3′,4,4′-tetracarboxylate.

In the resist composition of the invention, an appropriate amount of the dissolution inhibitor (E) is up to about 20 parts, and especially up to about 15 parts by weight per 100 parts by weight of the base resin in the composition. More than 20 parts of the dissolution inhibitor leads to resist compositions having poor heat resistance due to increased monomer contents.

In addition to the foregoing components, the resist composition of the invention may include optional ingredients, typically a surfactant which is commonly used for improving the coating characteristics. Optional ingredients may be added in conventional amounts so long as this does not compromise the objects of the invention.

A nonionic surfactant is preferred, examples of which include perfluoroalkyl polyoxyethylene ethanols, fluorinated alkyl esters, perfluoroalkylamine oxides, perfluoroalkyl EO-addition products, and fluorinated organosiloxane compounds. Illustrative examples include Fluorad FC-430 and FC-431 from Sumitomo 3M Ltd., Surflon S-141 and S-145 from Asahi Glass Co., Ltd., Unidyne DS-401, DS-403, and DS-451 from Daikin Industries Ltd., Megaface F-8151 from Dainippon Ink & Chemicals, Inc., and X-70-092 and X-70-093 from Shin-Etsu Chemical Co., Ltd. Preferred surfactants include Fluorad FC-430 from Sumitomo 3M Ltd. and X-70-093 from Shin-Etsu Chemical Co., Ltd.

Pattern formation using the resist composition of the invention may be carried out by a known lithographic technique. For example, the resist composition may be applied onto a substrate such as a silicon wafer by spin coating or the like to form a resist film having a thickness of 0.1 to 1.0 μm, which is then pre-baked on a hot plate at 60 to 200° C. for 10 seconds to 10 minutes, and preferably at 80 to 150° C. for ½ to 5 minutes. A patterning mask having the desired pattern may then be placed over the resist film, and the film exposed through the mask to an electron beam or to high-energy radiation such as deep-UV rays, excimer laser beams, or x-rays in a dose of about 1 to 200 mJ/cm², and preferably about 10 to 100 mJ/cm², then post-exposure baked (PEB) on a hot plate at 60 to 150° C. for 10 seconds to 5 minutes, and preferably at 80 to 130° C. for ½ to 3 minutes. Finally, development may be carried out using as the developer an aqueous alkali solution, such as 0.1 to 5 wt %, and preferably 2 to 3 wt %, tetramethylammonium hydroxide (TMAH), this being done by a conventional technique such as dip, puddle, or spray technique for a period of 10 seconds to 3 minutes, and preferably 30 seconds to 2 minutes. These steps result in the formation of the desired pattern on the substrate. Of the various types of high-energy radiation that may be used, the resist composition of the invention is best suited to micro-pattern formation with, in particular, deep-UV rays having a wavelength of 254 to 120 nm, an excimer laser, especially ArF excimer laser (193 nm), KrAr excimer laser (134 nm), F₂ laser (157 nm), Kr₂ laser (146 nm) or Ar₂ laser (126 nm), x-rays, or an electron beam. The desired pattern may not be obtainable outside the upper and lower limits of the above range.

### EXAMPLE

Examples of the invention are given below by way of illustration and not by way of limitation. The abbreviations used herein are LPO for lauroyl peroxide, NMR for nuclear magnetic resonance, Mw for weight average molecular weight, and Mn for number average molecular weight. Mw and Mn are determined by gel permeation chromatography (GPC) using polystyrene standards.

### Synthesis Example 1

### Copolymerization of Monomers 1 and 2

A 500-ml flask was charged with 12.68 g of Monomer 1, 7.32 g of Monomer 2, both shown below, and 3.53 g of toluene. After thorough dissolution, the system was purged of oxygen. In a nitrogen atmosphere, 0.376 g of LPO was fed to the flask, which was heated at 70° C. at which polymerization reaction took place for 30 hours.

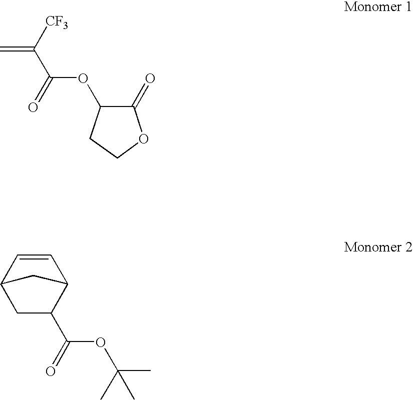

The polymer thus obtained was worked up by diluting the reaction mixture with tetrahydrofuran and pouring it into methanol whereupon the polymer precipitated. The polymer was washed with methanol, isolated and dried. There was obtained 14.6 g of a white polymer, which was found to have a Mw of 7,500 and a dispersity (Mw/Mn) of 1.5, as measured by GPC. On ¹H-NMR analysis, the polymer was found to consist of Monomer 1 and Monomer 2 in a molar ratio of 62:38.

### Synthesis Example 2

### Copolymerization of Monomers 3 and 2

A 500-ml flask was charged with 13.62 g of Monomer 3, 6.38 g of Monomer 2, both shown below, and 3.53 g of toluene. After thorough dissolution, the system was purged of oxygen. In a nitrogen atmosphere, 0.328 g of LPO was fed to the flask, which was heated at 70° C. at which polymerization reaction took place for 30 hours.

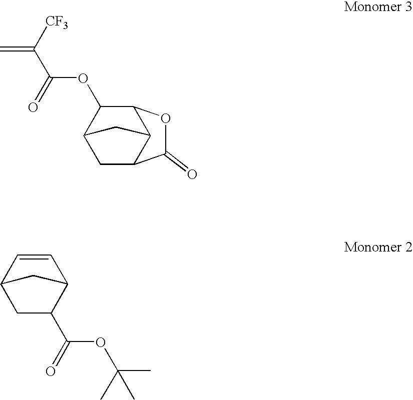

The polymer thus obtained was worked up by diluting the reaction mixture with tetrahydrofuran and pouring it into methanol whereupon the polymer precipitated. The polymer was washed with methanol, isolated and dried. There was obtained 14.0 g of a white polymer, which was found to have a Mw of 7,900 and a dispersity (Mw/Mn) of 1.5, as measured by GPC. On ¹H-NMR analysis, the polymer was found to consist of Monomer 3 and Monomer 2 in a molar ratio of 60:40.

### Synthesis Example 3

### Copolymerization of Monomers 4 and 2

A 500-ml flask was charged with 13.65 g of Monomer 4, 6.35 g of Monomer 2, both shown below, and 3.53 g of toluene. After thorough dissolution, the system was purged of oxygen. In a nitrogen atmosphere, 0.326 g of LPO was fed to the flask, which was heated at 70° C. at which polymerization reaction took place for 30 hours.

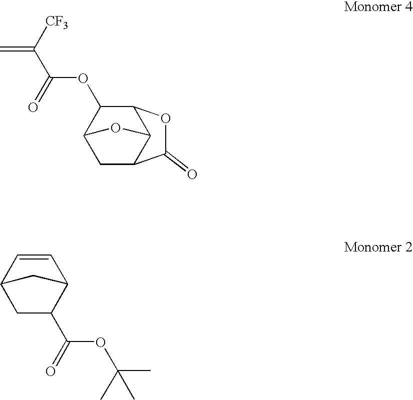

The polymer thus obtained was worked up by diluting the reaction mixture with tetrahydrofuran and pouring it into methanol whereupon the polymer precipitated. The polymer was washed with methanol, isolated and dried. There was obtained 14.2 g of a white polymer, which was found to have a Mw of 7,700 and a dispersity (Mw/Mn) of 1.5, as measured by GPC. On ¹H-NMR analysis, the polymer was found to consist of Monomer 4 and Monomer 2 in a molar ratio of 61:39.

### Synthesis Example 4

### Copolymerization of Monomers 4 and 5

A 500-ml flask was charged with 11.86 g of Monomer 4, 8.14 g of Monomer 5, both shown below, and 3.53 g of toluene. After thorough dissolution, the system was purged of oxygen. In a nitrogen atmosphere, 0.283 g of LPO was fed to the flask, which was heated at 70° C. at which polymerization reaction took place for 30 hours.

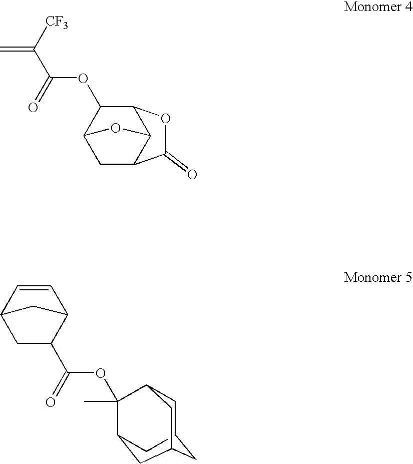

The polymer thus obtained was worked up by diluting the reaction mixture with tetrahydrofuran and pouring it into methanol whereupon the polymer precipitated. The polymer was washed with methanol, isolated and dried. There was obtained 14.9 g of a white polymer, which was found to have a Mw of 7,900 and a dispersity (Mw/Mn) of 1.5, as measured by GPC. On ¹H-NMR analysis, the polymer was found to consist of Monomer 4 and Monomer 5 in a molar ratio of 60:40.

### Synthesis Example 5

### Copolymerization of Monomers 4 and 6

A 500-ml flask was charged with 11.63 g of Monomer 4, 8.37 g of Monomer 6, both shown below, and 3.53 g of toluene. After thorough dissolution, the system was purged of oxygen. In a nitrogen atmosphere, 0.278 g of LPO was fed to the flask, which was heated at 70° C. at which polymerization reaction took place for 30 hours.

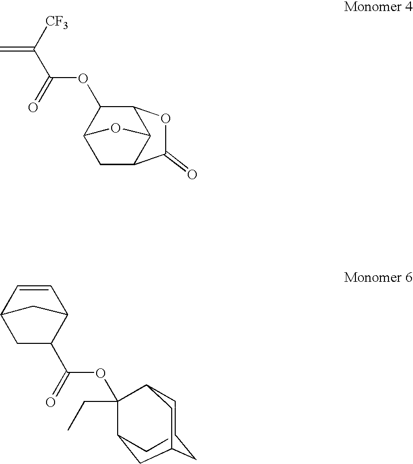

The polymer thus obtained was worked up by diluting the reaction mixture with tetrahydrofuran and pouring it into methanol whereupon the polymer precipitated. The polymer was washed with methanol, isolated and dried. There was obtained 14.0 g of a white polymer, which was found to have a Mw of 7,600 and a dispersity (Mw/Mn) of 1.5, as measured by GPC. On ¹H-NMR analysis, the polymer was found to consist of Monomer 4 and Monomer 6 in a molar ratio of 63:37.

### Synthesis Example 6

### Copolymerization of Monomers 4 and 7

A 500-ml flask was charged with 12.81 g of Monomer 4, 7.19 g of Monomer 7, both shown below, and 3.53 g of toluene. After thorough dissolution, the system was purged of oxygen. In a nitrogen atmosphere, 0.306 g of LPO was fed to the flask, which was heated at 70° C. at which polymerization reaction took place for 30 hours.

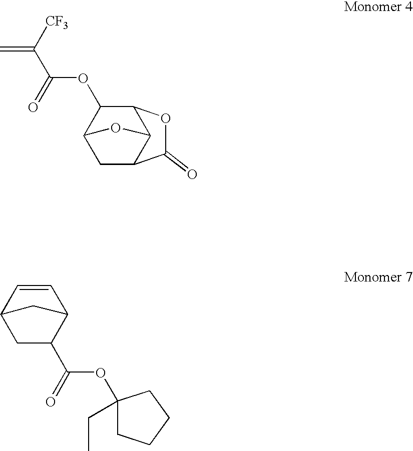

The polymer thus obtained was worked up by diluting the reaction mixture with tetrahydrofuran and pouring it into methanol whereupon the polymer precipitated. The polymer was washed with methanol, isolated and dried. There was obtained 14.2 g of a white polymer, which was found to have a Mw of 7,500 and a dispersity (Mw/Mn) of 1.5, as measured by GPC. On ¹H-NMR analysis, the polymer was found to consist of Monomer 4 and Monomer 7 in a molar ratio of 61:39.

### Synthesis Example 7

### Copolymerization of Monomers 4, 8a and 8b

A 500-ml flask was charged with 11.52 g of Monomer 4, 1.89 g of Monomer 8a, 6.59 g of Monomer 8b, all shown below, and 3.53 g of toluene. After thorough dissolution, the system was purged of oxygen. In a nitrogen atmosphere, 0.275 g of LPO was fed to the flask, which was heated at 70° C. at which polymerization reaction took place for 30 hours.

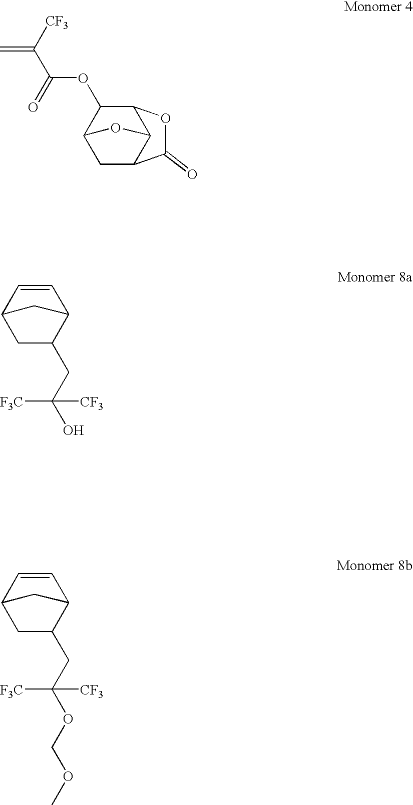

The polymer thus obtained was worked up by diluting the reaction mixture with tetrahydrofuran and pouring it into methanol whereupon the polymer precipitated. The polymer was washed with methanol, isolated and dried. There was obtained 14.5 g of a white polymer, which was found to have a Mw of 7,700 and a dispersity (Mw/Mn) of 1.5, as measured by GPC. On ¹H-NMR analysis, the polymer was found to consist of Monomer 4, Monomer 8a and Monomer 8b in a molar ratio of 60:8:32.

### Synthesis Example 8

### Copolymerization of Monomers 4, 9a and 9b

A 500-ml flask was charged with 13.28 g of Monomer 4, 1.42 g of Monomer 9a, 5.30 g of Monomer 9b, all shown below, and 3.53 g of toluene. After thorough dissolution, the system was purged of oxygen. In a nitrogen atmosphere, 0.317 g of LPO was fed to the flask, which was heated at 70° C. at which polymerization reaction took place for 30 hours.

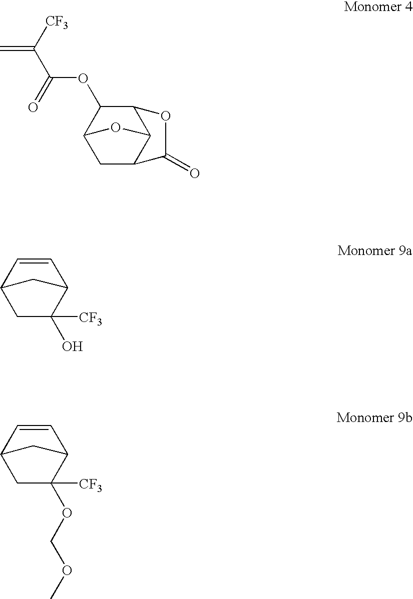

The polymer thus obtained was worked up by diluting the reaction mixture with tetrahydrofuran and pouring it into methanol whereupon the polymer precipitated. The polymer was washed with methanol, isolated and dried. There was obtained 14.7 g of a white polymer, which was found to have a Mw of 7,900 and a dispersity (Mw/Mn) of 1.5, as measured by GPC. On ¹H-NMR analysis, the polymer was found to consist of Monomer 4, Monomer 9a and Monomer 9b in a molar ratio of 61:8:31.

### Comparative Synthesis Example 1

### Copolymerization of Monomers 10, 11 and 12

A 500-ml flask was charged with 32.3 g of Monomer 10, 20.3 g of Monomer 11, 23.6 g of Monomer 12, all shown below, which were dissolved in 200 ml of toluene. The system was fully purged of oxygen. In a nitrogen atmosphere, 0.38 g of 2,2′-azobisisobutyronitrile was fed to the flask, which was heated at 60° C. at which polymerization reaction took place for 24 hours.

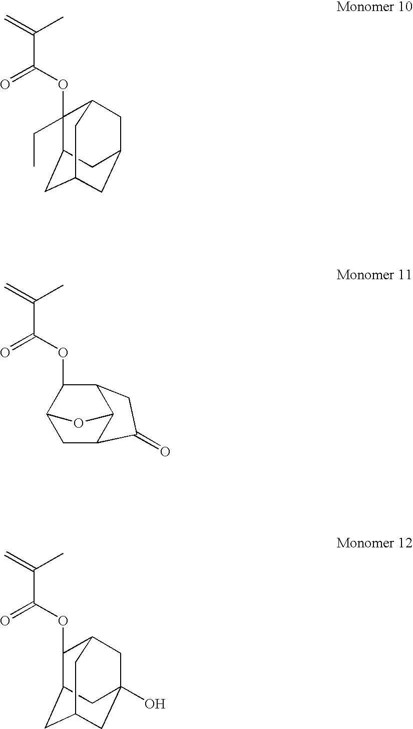

The polymer thus obtained was worked up by pouring the reaction mixture into methanol whereupon the polymer precipitated. The polymer was washed with methanol, isolated and dried. There was obtained 53.8 g of a white polymer, which was found to have a Mw of 7,200 and a dispersity (Mw/Mn) of 1.4, as measured by GPC. On ¹H-NMR analysis, the polymer was found to consist of Monomer 10, Monomer 11 and Monomer 12 in a molar ratio of 38:31:31.

Resist Preparation and Exposure

Resist solutions were prepared in a conventional manner by formulating the polymer, photoacid generator (PAG1 to PAG3), basic compound, dissolution inhibitor (DRIL) and solvent (PGMEA) in the amounts shown in Table 1. 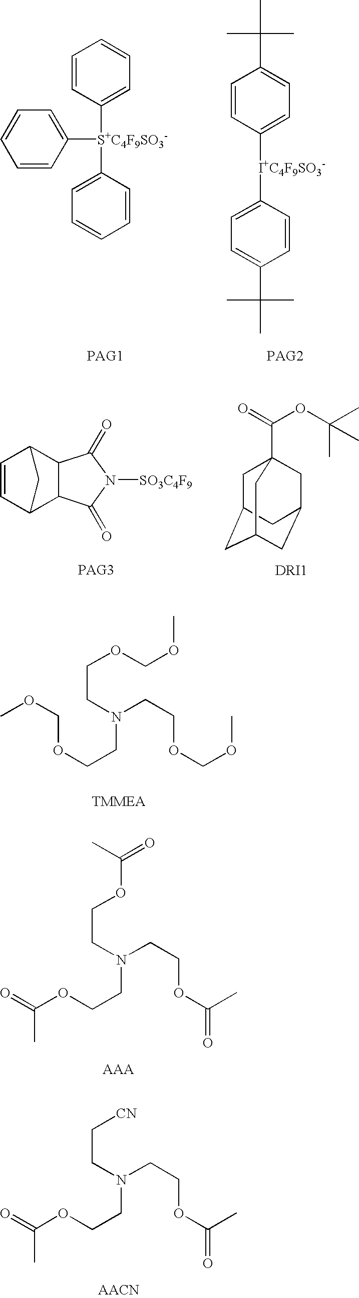
TEA: triethanolamine
PGMEA: propylene glycol monomethyl ether acetate

On silicon wafers having a film of DUV-30 (Brewer Science) coated to a thickness of 38 nm, the resist solutions were spin coated, then baked on a hot plate at 120° C. for 90 seconds to give resist films having a thickness of 200 nm.

The resist films were exposed by means of an ArF excimer laser scanner model NSR-S305B (Nikon Corp., NA 0.68, σ 0.85, ⅔ annular illumination, ordinary mask) while varying the exposure dose. Immediately after exposure, the resist films were baked at 120° C. for 90 seconds and then developed for 60 seconds with a 2.38 wt % aqueous solution of tetramethylammonium hydroxide.

The exposure dose which provided a resolution to a 0.12-μm 1:1 line-and-space pattern was the optimum exposure dose (Eop), that is, a sensitivity (mJ/cm²). The minimum line width (nm) of a 1:1 L/S pattern which was ascertained separate at this dose (Eop) was the resolution of a test resist. Using a measuring SEM model S-9220 (Hitachi Ltd.), the 0.12-μm 1:1 L/S pattern was measured for line edge roughness. The results are also shown in Table 1.

TABLE 1

| | Photoacid | Basic | Dissolution | | | | Line edge |
|---|---|---|---|---|---|---|---|
| Polymer | generator | compound | inhibitor | Solvent | Sensitivity | Resolution | roughness |
| (pbw) | (pbw) | (pbw) | (pbw) | (pbw) | (mJ/cm²) | (nm) | (nm) |
| Synthesis | PAG1 | TMMEA | — | PGMEA | 28 | 110 | 6.8 |
| Example 1 | (3) | (0.4) | | (800) | | | |
| (100) | | | | | | | |
| Synthesis | PAG1 | TMMEA | — | PGMEA | 32 | 110 | 6.9 |
| Example 2 | (3) | (0.4) | | (800) | | | |
| (100) | | | | | | | |
| Synthesis | PAG1 | TMMEA | — | PGMEA | 35 | 110 | 6.6 |
| Example 3 | (3) | (0.4) | | (800) | | | |
| (100) | | | | | | | |
| Synthesis | PAG1 | TMMEA | — | PGMEA | 26 | 110 | 7.1 |
| Example 4 | (3) | (0.4) | | (800) | | | |
| (100) | | | | | | | |
| Synthesis | PAG1 | TMMEA | — | PGMEA | 24 | 110 | 6.6 |
| Example 5 | (3) | (0.4) | | (800) | | | |
| (100) | | | | | | | |
| Synthesis | PAG1 | TMMEA | — | PGMEA | 22 | 110 | 6.2 |
| Example 6 | (3) | (0.4) | | (800) | | | |
| (100) | | | | | | | |
| Synthesis | PAG1 | TMMEA | — | PGMEA | 20 | 110 | 6.8 |
| Example 7 | (3) | (0.4) | | (800) | | | |
| (100) | | | | | | | |
| Synthesis | PAG1 | TMMEA | — | PGMEA | 26 | 110 | 6.6 |
| Example 8 | (3) | (0.4) | | (800) | | | |
| (100) | | | | | | | |
| Synthesis | PAG2(4) | TMMEA | — | PGMEA | 26 | 110 | 6.2 |
| Example 1 | PAG3(3) | (0.2) | | (800) | | | |
| (100) | | | | | | | |
| Synthesis | PAG1 | AAA | — | PGMEA | 34 | 110 | 6.6 |
| Example 1 | (3) | (0.4) | | (800) | | | |
| (100) | | | | | | | |
| Synthesis | PAG1 | AACN | — | PGMEA | 36 | 110 | 6.9 |
| Example 1 | (3) | (0.4) | | (800) | | | |
| (100) | | | | | | | |
| Synthesis | PAG1 | TMMEA | DRI1 | PGMEA | 22 | 110 | 6.1 |
| Example 4 | (3) | (0.4) | (10) | (800) | | | |
| (100) | | | | | | | |
| Comparative | PAG1 | TEA | — | PGMEA | 31 | 100 | 8.9 |
| Synthesis | (3) | (0.2) | | (800) | | | |
| Example 1 | | | | | | | |
| (100) | | | | | | | |

Dry Etching Test

Each polymer, 2 g, was thoroughly dissolved in 10 g of PGMEA, and passed through a filter having a pore size of 0.2 μm, obtaining a polymer solution. The polymer solution was spin coated onto a silicon substrate and baked, forming a polymer film of 300 nm thick. Dry etching tests were carried out on the polymer films by etching them under two sets of conditions. In an etching test with CHF₃/CF₄ gas, a dry etching instrument TE-8500P (Tokyo Electron K.K.) was used. In an etching test with Cl₂/BCl₃ gas, a dry etching instrument L-507D-L (Nichiden Anerba K.K.) was used. In each test, the difference in polymer film thickness before and after etching was determined. The etching conditions are summarized in Table 2.

TABLE 2

| | CHF₃/CF₄ gas | Cl₂/BCl₃ gas |
|---|---|---|
| Chamber pressure (Pa) | 40.0 | 40.0 |
| RF power (W) | 1300 | 300 |
| Gap (mm) | 9 | 9 |
| Gas flow rate (ml/min) | CHF₃: 30 | Cl₂: 30 |
| | CF₄: 30 | BCl₃: 30 |
| | Ar: 100 | CHF₃: 100 |
| | | O₂: 2 |
| Time (sec) | 60 | 60 |

The results of etching tests are shown in Table 3. In this evaluation, a less difference in polymer film thickness, i.e., a less film loss indicates more etching resistance. It is seen that inventive resist compositions are also improved in etching resistance.

TABLE 3

| | CHF₃/CF₄ gas | Cl₂/BCl₃ gas |
|---|---|---|
| | etching rate | etching rate |
| Polymer | (nm/min) | (nm/min) |
| Synthesis Example 1 | 139 | 148 |
| Synthesis Example 2 | 138 | 143 |
| Synthesis Example 3 | 133 | 140 |
| Synthesis Example 4 | 120 | 140 |
| Synthesis Example 5 | 121 | 136 |
| Synthesis Example 6 | 128 | 140 |
| Synthesis Example 7 | 138 | 148 |
| Synthesis Example 8 | 136 | 142 |
| Comparative Synthesis Example 1 | 142 | 155 |

Roughness Measurement

Using AFM (Digital Instruments, Model Nano-Scope 3A Dimension 5000), irregularities on the surface of the polymer film after CHF₃/CF₄ gas etching were measured. A root mean square (RMS) of AFM measurements was computed and reported as surface roughness. The results are shown in Table 4.

TABLE 4

| | Surface roughness (nm) |
|---|---|
| Polymer | after CHF₃/CF₄ gas etching |
| Synthesis Example 1 | 6.2 |
| Synthesis Example 2 | 5.7 |
| Synthesis Example 3 | 5.2 |
| Synthesis Example 4 | 3.9 |
| Synthesis Example 5 | 3.6 |
| Synthesis Example 6 | 4.3 |
| Synthesis Example 7 | 6.2 |
| Synthesis Example 8 | 6.3 |
| Comparative Synthesis | 17.8 |
| Example 1 | |

As is evident from Tables 1 to 4, resist compositions using inventive polymers, when processed through ArF exposure, demonstrate an excellent resolution, minimized line edge roughness, and good etching resistance, and especially minimized surface roughness after etching.

Japanese Patent Application No. 2004-031526 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A polymer comprising recurring units of the general formulae (1a) and (1b) and having a weight average molecular weight of 1,000 to 500,000, 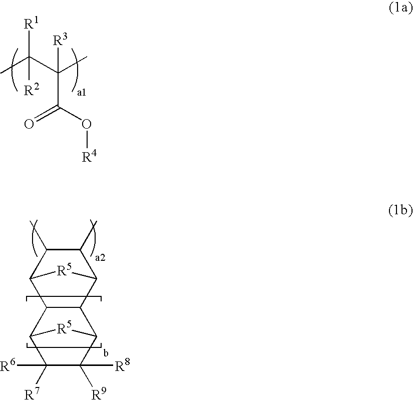
wherein R¹ and R² each are a hydrogen or fluorine atom, R³ is a fluorine atom or a straight, branched or cyclic fluoroalkyl group of 1 to 20 carbon atoms, R⁴ is hydrogen or an adhesive group, R⁵ is a methylene group or oxygen atom, R⁶ to R⁹ each are a hydrogen atom, fluorine atom, cyano group, straight, branched or cyclic alkyl or fluoroalkyl group of 1 to 20 carbon atoms, —OR¹¹, —R¹⁰—CO₂R¹¹ or —R¹⁰—C(R¹²) (R¹³)—OR¹¹, R¹⁰ is a straight, branched or cyclic alkylene or fluoroalkylene group of 1 to 10 carbon atoms, R¹¹ is hydrogen or an acid labile group, R¹² and R¹³ each are hydrogen or a straight, branched or cyclic alkyl or fluoroalkyl group of 1 to 10 carbon atoms, at least one of R⁶ to R⁹ contains —R¹⁰—CO₂R¹¹ or —R¹⁰—C(R¹²)(R¹³)—OR¹¹, at least 5 mol % of R¹¹ are acid labile groups, the subscripts a1 and a2 are numbers satisfying 0<a1<1, 0<a2<1, and 0<a1+a2≦1, and b is 0 or 1.

2. The polymer of claim 1, wherein R³ is trifluoromethyl.

3. The polymer of claim 1, wherein the adhesive group represented by R⁴ is selected from the group consisting of groups of the following formulae:

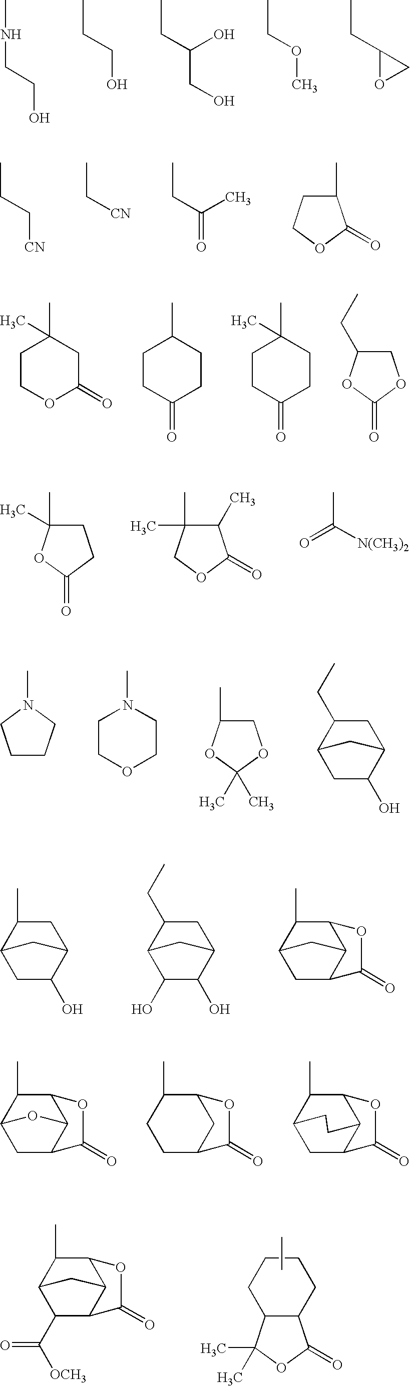

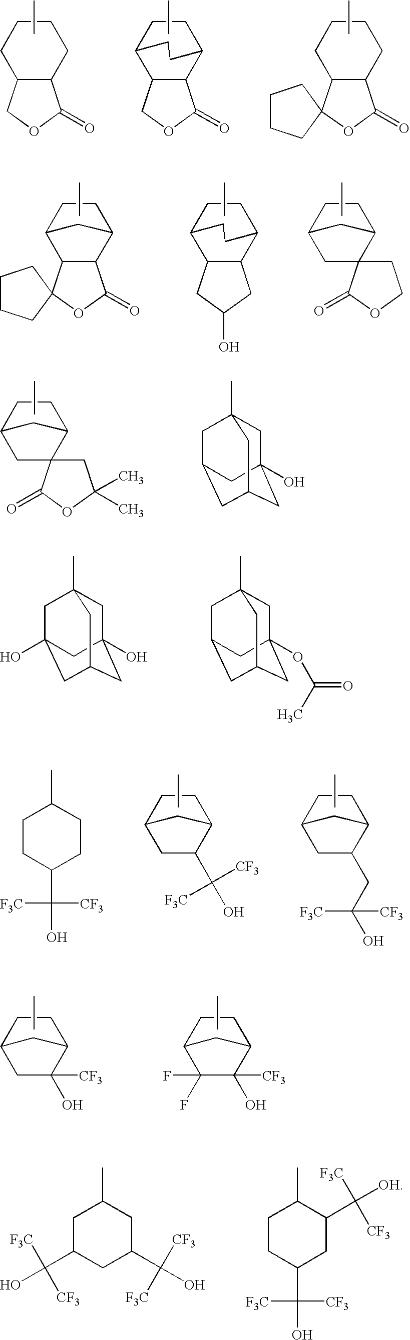

4. The polymer of claim 1 wherein the acid labile group represented by R¹¹ is selected from the group consisting of groups of the following formulae (AL-1) to (AL-3): 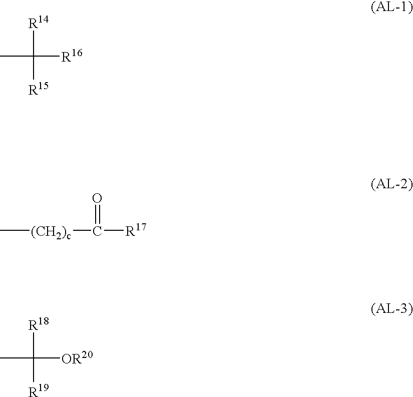
wherein, R¹⁴, R¹⁵ and R¹⁶ may be the same or different and stand for straight, branched or cyclic hydrocarbon groups of 1 to 20 carbon atoms, which may contain a hetero atom such as oxygen, sulfur or nitrogen, or bridged cyclic hydrocarbon groups, alternatively, a pair of R¹⁴ and R¹⁵ , R¹⁴ and R¹⁶, and R¹⁵ and R¹⁶, taken together, may form a ring of 5 to 20 carbon atoms with the carbon atom to which they are bonded, R¹⁷ and R²⁰ stand for straight, branched or cyclic alkyl groups of 1 to 20 carbon atoms, which may contain a hetero atom such as oxygen, sulfur, nitrogen or fluorine, R¹⁸ and R¹⁹ stand for hydrogen or straight, branched or cyclic alkyl groups of 1 to 20 carbon atoms, which may contain a hetero atom such as oxygen, sulfur, nitrogen or fluorine, alternatively, a pair of R¹⁸ and R¹⁹, R¹⁸ and R²⁰, and R¹⁹ and R²⁰, taken together, may form a ring of 5 to 20 carbon atoms with the carbon atom or carbon and oxygen atoms to which they are bonded, the subscript c is an integer of 0 to 6.

5. The polymer of claim 1, which further comprises a recurring unit selected from the group consisting of the following list of formula (1c): 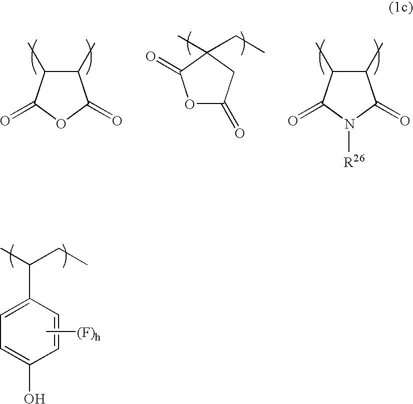
wherein R²⁶ is a straight, branched or cyclic alkyl group of 1 to 10 carbon atoms, and h is a number of 0 to 4.

6. A resist composition comprising the polymer of claim 1.

7. A chemically amplified positive resist composition comprising
(A) the polymer of claim 1,
(B) an organic solvent, and
(C) a photoacid generator.

8. The resist composition of claim 7, further comprising (D) a basic compound.

9. The resist composition of claim 7, further comprising (E) a dissolution inhibitor.

10. A process for forming a pattern comprising the steps of:
applying the resist composition of claim 6 onto a substrate to form a coating,
heat treating the coating and then exposing it to high-energy radiation having a wavelength of up to 200 nm through a photomask, and
optionally heat treating the exposed coating and developing it with a developer.

11. The process of claim 10, wherein the high-energy radiation is an ArF excimer laser beam.
